(19) United States
(12) Patent Application Publication
(10) Pub. No.: US 2025/0350964 A1
(43) Pub. Date: Nov. 13, 2025

(54) TRANSMISSION APPARATUS, TRANSMISSION METHOD, AND PROGRAM

(71) Applicant: Sony Group Corporation, Tokyo (JP)

(72) Inventors: Shuichiro Nishigori, Tokyo (JP); Chisato Kenmochi, Kanagawa (JP); Hirofumi Takeda, Kanagawa (JP)

(73) Assignee: Sony Group Corporation, Tokyo (JP)

(21) Appl. No.: 18/718,906

(22) PCT Filed: Dec. 9, 2022
(86) PCT No.: PCT/JP2022/045477

§ 371 Date: Jun. 6, 2025

(30) Foreign Application Priority Data
Dec. 24, 2021 (JP) 2021-210221

(51) Int. Cl. H04W 24/02

(52) U.S. Cl. CPC H04W 24/02

(57) ABSTRACT

The present technology relates to a transmission apparatus, a transmission method, and a program that can more suitably eliminate a delay in transmission of a media signal.

The transmission apparatus of the present technology includes: an acquisition unit that acquires a media signal; a selection unit that selects the media signal of a transmission target on the basis of context information calculated for the media signal; and a communication unit that transmits the media signal selected as the transmission target. In addition, the media signal includes at least one of a video signal, an audio signal, or a tactile signal. The present technology can be applied to, for example, a system that realizes a remote live in which a remote audience can participate from outside the live venue.

### TECHNICAL FIELD

The present technology relates to a transmission apparatus, a transmission method, and a program, and more particularly, to a transmission apparatus, a transmission method, and a program capable of more suitably eliminating a delay in transmission of a media signal.

### BACKGROUND ART

In recent years, a large number of remote live events have been held. In the remote live, a video obtained by capturing a state of a performer or an audience from a live venue where entertainment such as music or a play is performed is distributed in real time to terminals used by the audience (hereinafter referred to as remote audience) outside the live venue.

Patent Documents 1 to 3 disclose a system that displays a video reflecting a motion of a remote audience in order to obtain a sense that the remote audience is participating in an event and a sense of unity with a performer and other audience.

Furthermore, Non-Patent Document 1 discloses a system in which each of previously selected audience among remote audiences records a video and an audio using a camera and a microphone, and transmits a media signal indicating the recorded video, audio, and the like to a live venue in real time. In this system, a video of the facial expression and movement of the remote audience is displayed on the display of the live venue, and the voice is output from the speaker, so that the remote audience can support the performer from outside the venue.

In these systems, for example, a method is used in which media signals of the performer and all the remote audiences are temporarily stored in a server, and the media signals of the performer and all the remote audiences are synchronized and transmitted to each terminal. In this method, when the time until the server receives the media signal becomes long due to the difference in the communication status between the terminal used by each remote audience and the server or the like, a large delay occurs from the acquisition of the media signal to the reproduction thereof, and a sense of discomfort of experience occurs.

In order to eliminate the delay, for example, a method (see, for example, Patent Document 4) is used in which a waiting time until the server receives a media signal is fixed, and each media signal is selected according to a delay time and transmitted to each terminal.

### CITATION LIST

### Patent Document

Patent Document 1: Japanese Patent Application Laid-Open No. 2013-21466
Patent Document 2: Japanese Patent Application Laid-Open No. 2019-50576
Patent Document 3: Japanese Patent Application Laid-Open No. 2020-194030
Patent Document 4: Japanese Patent Application Laid-Open No. 2000-209177

### Non-Patent Document

Non-Patent Document 1: “Beyond LIVE”, [online], retrieved on Nov. 16, 2021, the Internet <URL: https://campaign.naver.com/pr/v/beyondlive/ja/>

### SUMMARY OF THE INVENTION

### Problems to be Solved by the Invention

However, in the method disclosed in Patent Document 4, the importance of each media signal, the relationship between remote audiences, and the like are not considered. For this reason, fanchants, cheers, or the like of the audience, which is an important element in the live, is treated equivalently with an unimportant element. Therefore, data interruption or the like greatly affects important elements, and a sense of discomfort in experience may occur.

The present technology has been made in view of such a situation, and an object thereof is to more suitably reduce a delay in transmission of a media signal.

### Solutions to Problems

A transmission apparatus according to one aspect of the present technology includes: an acquisition unit that acquires a media signal; a selection unit that selects the media signal of a transmission target on the basis of context information calculated for the media signal; and a communication unit that transmits the media signal selected as the transmission target.

In a transmission method according to one aspect of the present technology includes: by a transmission apparatus, acquiring a media signal; selecting the media signal of a transmission target on the basis of context information calculated for the media signal; and transmitting the media signal selected as the transmission target.

A program according to one aspect of the present technology causes a computer to execute processing of: acquiring a media signal; selecting the media signal of a transmission target on the basis of context information calculated for the media signal; and transmitting the media signal selected as the transmission target.

In one aspect of the present technology, a media signal is acquired, the media signal of a transmission target is selected on the basis of context information calculated for the media signal, and the media signal selected as the transmission target is transmitted.

### BRIEF DESCRIPTION OF DRAWINGS

FIG. 1 is a diagram illustrating a configuration example of an embodiment of a remote live system to which the present technology is applied.

FIG. 2 is a diagram illustrating an example of data to be transmitted.

FIG. 3 is a diagram illustrating an example of data to be transmitted.

FIG. 4 is a timing chart illustrating an example of a flow of communication in a remote live system.

FIG. 5 is a timing chart illustrating another example of a communication flow in the remote live system.

FIG. 6 is a diagram illustrating a configuration example of an apparatus used by a performer side.

FIG. 7 is a block diagram illustrating a configuration example of a transmission apparatus.

FIG. 8 is a diagram illustrating a configuration example of an apparatus used by a remote audience.

FIG. 9 is a block diagram illustrating a configuration example of a transmission apparatus.

FIG. 10 is a block diagram illustrating a functional configuration example of an encoding unit.

FIG. 11 is a diagram illustrating an example of a DNN learning method.

FIG. 12 is a flowchart illustrating transmission processing performed by a transmission apparatus.

FIG. 13 is a flowchart illustrating selection processing performed in step S4 in FIG. 12.

FIG. 14 is a block diagram illustrating a configuration example of a server.

FIG. 15 is a block diagram illustrating a configuration example of an encoding unit.

FIG. 16 is a diagram illustrating an example of a media signal for performers and a media signal for remote audience in Case 2.

FIG. 17 is a diagram illustrating an example of a state of a live venue.

FIG. 18 is a flowchart illustrating transmission processing performed by a server.

FIG. 19 is a flowchart illustrating video signal synthesis processing performed in step S53 in FIG. 18.

FIG. 20 is a flowchart illustrating audio signal synthesis processing performed in step S54 in FIG. 18.

FIG. 21 is a flowchart illustrating tactile signal selection processing performed in step S55 in FIG. 18.

FIG. 22 is a diagram illustrating an example of smoothing processing.

FIG. 23 is a diagram illustrating another example of smoothing processing.

FIG. 24 is a block diagram illustrating a configuration example of hardware of a computer.

### MODE FOR CARRYING OUT THE INVENTION

Hereinafter, a mode for carrying out the present technology will be described. The description is given in the following order.
1. Overview of Remote Live System
2. Configuration of Apparatus on Performer Side
3. Configuration and Operation of Apparatus on Remote Audience Side
4. Configuration and Operation of Server
5. Modification

### 1. Overview of Remote Live System

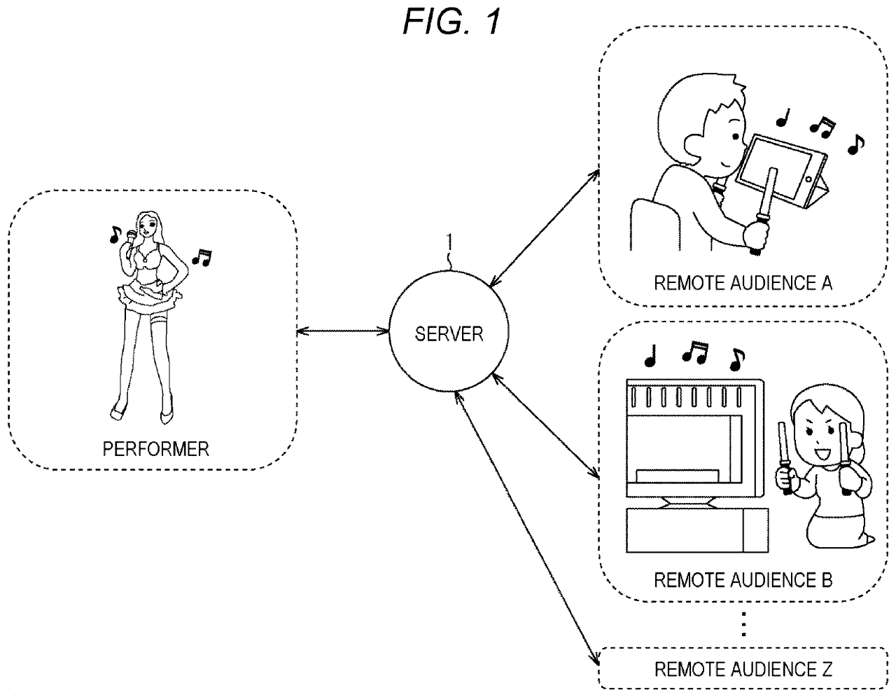

FIG. 1 is a diagram illustrating a configuration example of an embodiment of a remote live system to which the present technology is applied.

In the remote live system, a remote live is realized in which a video or the like obtained by capturing a state of a performer is distributed in real time from a live venue where entertainment such as music or a play is performed to a terminal used by a remote audience outside the live venue.

In the example of FIG. 1, remote audiences A to Z participating in the remote live at a place outside the live venue such as a home or a facility such as a karaoke box are illustrated. For example, remote audience A participates in the remote live by using a tablet terminal, and remote audience B participates in the remote live by using a personal computer (PC).

Note that the number of remote audiences (users) is not limited to 26, and more remote audiences actually participates in the remote live.

The remote live system of FIG. 1 is configured by connecting a terminal used by a performer side and terminals used by remote audiences A to Z to a server 1 managed by an operator of the remote live via a network such as the Internet. Note that the terminal used by the performer side and the server 1 may be directly connected wirelessly or by wire.

In the live venue, a video signal obtained by capturing the state of the performer, an audio signal obtained by collecting the audio or the like of the performer, and a tactile signal for reproducing the feel at the time of shaking hands with the performer are acquired. Note that, in a case where an audience is also present in the live venue, a video signal obtained by capturing the state of the audience together with the performer and an audio signal obtained by collecting the cheers or the like of the audience together with the voice of the performer may be acquired in the live venue.

Furthermore, in the terminal on the remote audience side, a video signal obtained by capturing the faces and movement states of the respective remote audiences A to Z, an audio signal obtained by picking up the cheers, applause, fanchants, and the like of the remote audience, and a tactile signal are acquired. On the basis of the tactile signal, physical contact such as high five between the remote audiences in the virtual space, strength with which the remote audiences A to Z hold the penlights, intensity with which the remote audiences A to Z shake the penlights, and the like are reproduced.

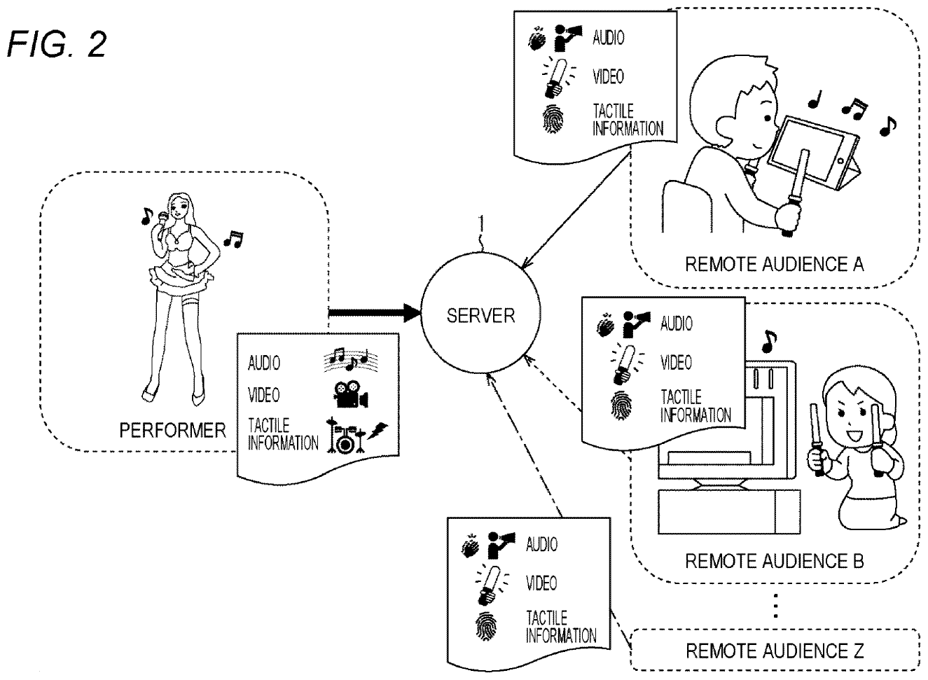

During the period of the remote live, as illustrated in FIG. 2, a media signal including a video signal, an audio signal, and a tactile signal on the performer side acquired at the live venue, and a media signal including a video signal, an audio signal, and a tactile signal on the remote audience side acquired at the terminals used by the remote audiences A to Z are transmitted to the server 1.

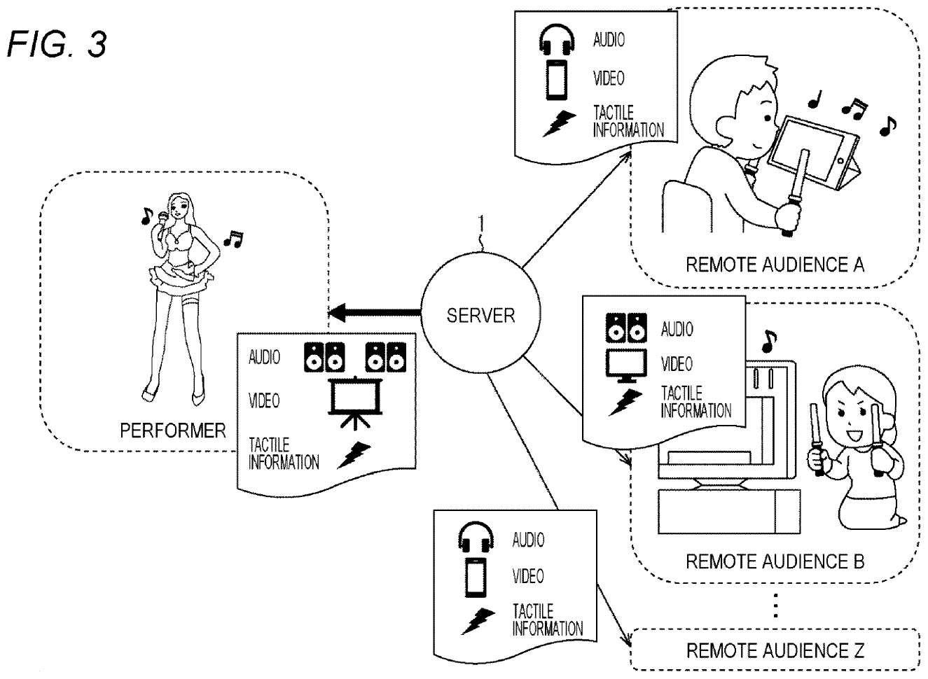

In this case, for example, the server 1 synthesizes the media signal of the remote audience side for each type of media signal, and transmits the obtained media signal to the terminal used by the performer side as illustrated in FIG. 3. Furthermore, the server 1 synthesizes a media signal on the performer side and a media signal on the remote audience side for each type of media signal, and transmits the obtained media signals to terminals used by the remote audiences A to Z, respectively.

Note that, in FIGS. 1 to 3, one server 1 is at the center and processes the data of the performers and all the remote audiences A to Z, but it is also possible to provide an edge server (intermediate server existing near each of the remote audiences A to Z) between the server 1 and each of the remote audiences A to Z.

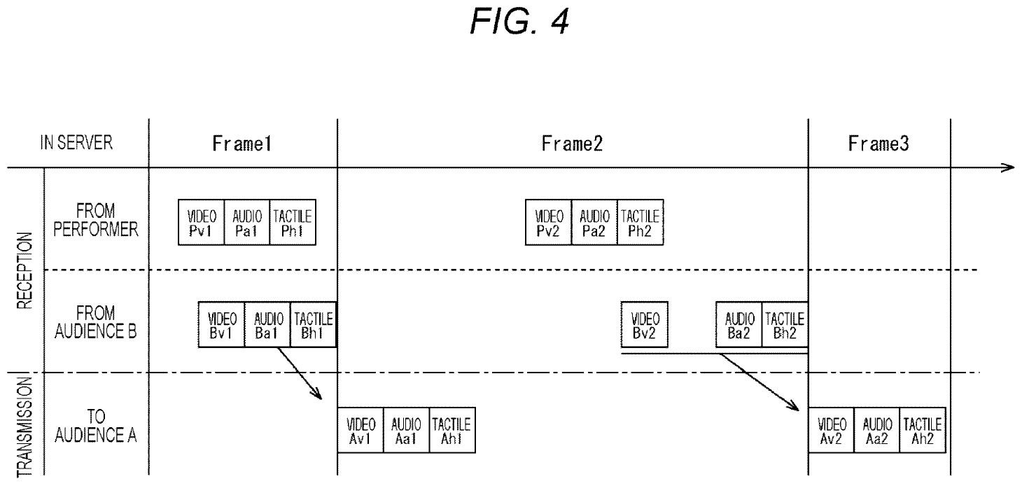

FIG. 4 is a timing chart illustrating an example of a flow of communication in the remote live system. In FIG. 4, in order to simplify the description, a flow is illustrated in which the server 1 receives data of the performer side and the remote audience B side, synthesizes the data, and transmits the synthesized data to the terminal used by the remote audience A.

In FIG. 4, a frame indicates a time width required for transmission and reception of data packets (communication units divided by a certain size) including media signals on the performer side and the remote audience B side.

In the example of FIG. 4, in the frame 1, the data packets Pv1, Pa1, and Ph1 transmitted from the terminal used by the performer side and the data packets Bv1, Ba1, and Bh1 transmitted from the terminal used by the remote audience B are received. The data packets Pv1 and Bv1 include video signals, and the data packets Pa1 and Ba1 include audio signals. The data packets Ph1 and Bh1 include tactile signals.

In the frame 2, the data packets Pv2, Pa2, and Ph2 transmitted from the terminal used by the performer side and the data packets Bv2, Ba2, and Bh2 transmitted from the terminal used by the remote audience B are received. The data packets Pv2 and Bv2 include video signals, and the data packets Pa2 and Ba2 include audio signals. The data packets Ph2 and Bh2 include tactile signals.

Furthermore, in the frame 2, data packets Av1, Aa1, and Ah1 including media signals obtained by synthesizing the media signals of the performer side and the remote audience B side received in the frame 1 are transmitted to the terminal used by the remote audience A.

In the frame 3, data packets Av2, Aa2, and Ah2 including media signals obtained by synthesizing the media signals of the performer side and the remote audience B side received in the frame 2 are transmitted to the terminal used by the remote audience A.

In a remote live system, in a case where it is considered that communication of data packets including respective media signals of a performer side and a remote audience B side is completely synchronized by a server/client model, a time for waiting for all data to be prepared on the server 1 side may become long due to a large number of remote audiences and a difference in communication status between each terminal and the server 1.

In the example of FIG. 4, a delay occurs in the transmission of the data packets zuBa2 and Bh2, so that the frame 2 becomes long, and the transmission of the data packets Av2, Aa2, and Ah2 in the frame 3 is delayed. When the frame becomes long, a large delay occurs in the entire communication of the remote live system, and a sense of discomfort occurs in the remote live experience.

In order to solve such a delay in communication, if the number of connections of the remote audience is limited or the number of connections of the remote audience is limited so that only the remote audience having a good communication environment can participate in the remote live, the fun of the live in which a large number of people participate is reduced.

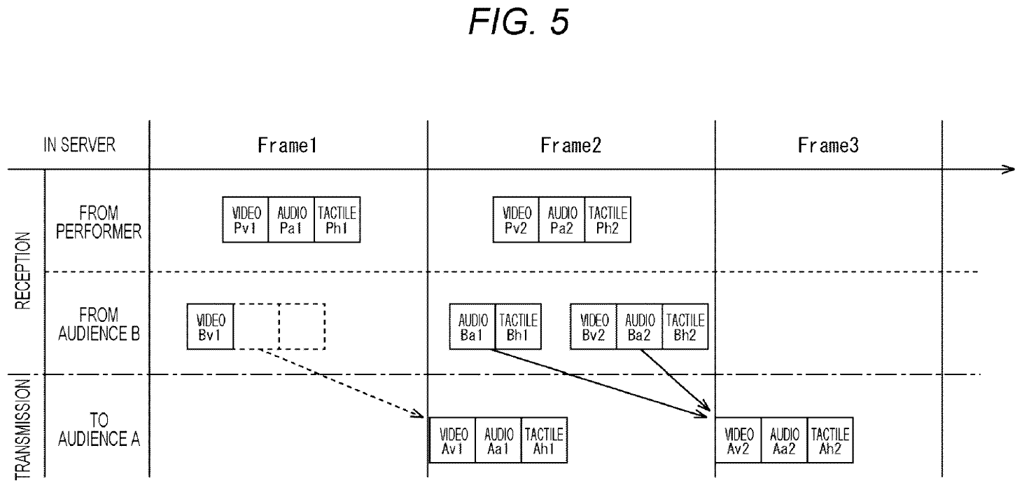

FIG. 5 is a timing chart illustrating another example of the flow of communication in the remote live system.

In the example of FIG. 5, in the frame 1, data packets Pv1, Pa1, and Ph1 transmitted from the terminal used by the performer side and a data packet Bv1 transmitted from the terminal used by the remote audience B are received.

In the frame 2, data packets Pv2, Pa2, and Ph2 transmitted from the terminal used by the performer side and data packets Ba1, Bh1, Bv2, Ba2, and Bh2 transmitted from the terminal used by the remote audience B are received.

In this case, the data packet Av1 transmitted to the terminal used by the remote audience A in the frame 2 includes a video signal obtained by synthesizing the video signal of the performer side and the video signal of the remote audience B side received in the frame 1. On the other hand, the data packets Aa1 and Ah1 include only the audio signal and the tactile signal of the performer side received in the frame 1, respectively.

In addition, the data packet Av1 transmitted to the terminal used by the remote audience A in the frame 3 includes a video signal obtained by synthesizing the video signal of the performer side and the video signal of the remote audience B side received in the frame 2. On the other hand, the data packets Aa2 and Ah2 include an audio signal and a tactile signal in which the audio signal and the tactile signal included in the data packets Ba1 and Bh1 are thinned out or fast-forwarded and reflected.

As described above, in a case where the length of the frame is fixed in order to eliminate the delay of communication, data that has not reached is indiscriminately lost and transmitted in the frame, which causes a sense of discomfort in experience.

In order to reduce the sense of discomfort of experience that occurs in a case where the length of the frame is fixed, for example, Patent Document 4 has devised a technique of selecting each media signal according to the delay time. In the technology disclosed in Patent Document 4, communication can be efficiently performed, but a context indicating the importance of each media signal, the relationship between remote audiences, and the like is not considered.

If the length of the frame is shortened in a state where the context is not considered, important elements and unimportant elements are treated equivalently in the remote live. For example, fanchants, cheers, and the like of the remote audience are regarded as important elements in the remote live, and the video of the face of the remote audience with little change and the noise sound and the like emitted by the remote audience are regarded as unimportant elements.

When an important element and an unimportant element are treated equivalently, data interruption or the like greatly affects the important element, and a sense of discomfort in experience may occur.

An embodiment of the present technology has been made in view of such circumstances, and proposes a technology capable of reducing the delay in communication of the entire remote live system while performing transmission in consideration of the context of the media signal of each remote audience and maintaining the quality of experience at a level at which there is no sense of discomfort in a large-scale bidirectional remote live.

### 2. Configuration of Apparatus on Performer Side

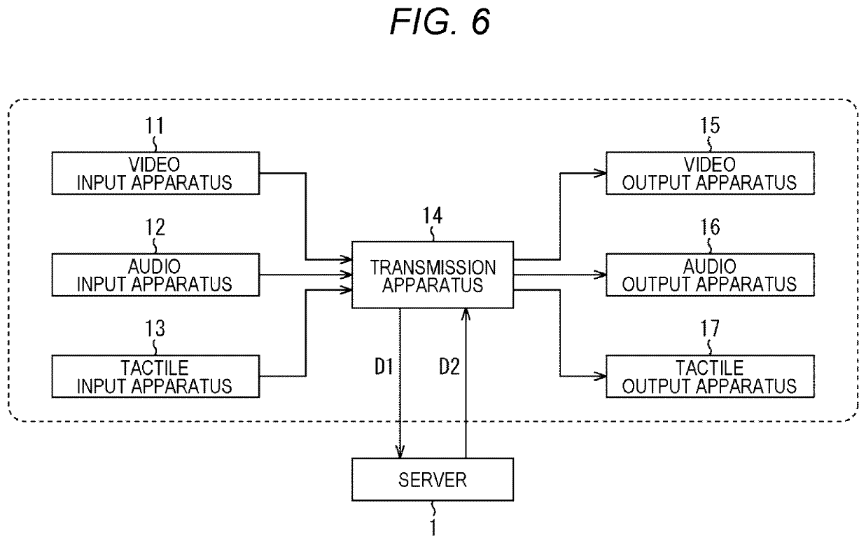

FIG. 6 is a diagram illustrating a configuration example of an apparatus used by a performer side.

As illustrated in FIG. 6, in the live venue, a video input apparatus 11, an audio input apparatus 12, a tactile input apparatus 13, a transmission apparatus 14, a video output apparatus 15, an audio output apparatus 16, and a tactile output apparatus 17 are provided. The video input apparatus 11, the audio input apparatus 12, the tactile input apparatus 13, the video output apparatus 15, the audio output apparatus 16, and the tactile output apparatus 17 are provided as equipment of a stage, and are connected to the transmission apparatus 14.

The video input apparatus 11 includes a camera or the like, and supplies a video signal obtained by capturing a performer or the like to the transmission apparatus 14.

The audio input apparatus 12 includes a microphone or the like, and supplies an audio signal obtained by collecting a voice of a performer or the like to the transmission apparatus 14.

The tactile input apparatus 13 includes an acceleration sensor or the like, detects a tactile signal on the performer side, and supplies the tactile signal to the transmission apparatus 14.

The transmission apparatus 14 includes, for example, a computer such as a PC. The transmission apparatus 14 transmits data packets in a certain time unit obtained by encoding and multiplexing each media signal input from the video input apparatus 11, the audio input apparatus 12, and the tactile input apparatus 13 to the server 1 as the performer data D1.

In addition, in parallel with the transmission of the performer data D1, the transmission apparatus 14 receives the feedback data D2 transmitted from the server 1, demultiplexes and decodes the feedback data D2, and acquires each media signal. The media signal of the remote audience side is synthesized with the media signal. The video signal is supplied to the video output apparatus 15, and the audio signal is supplied to the audio output apparatus 16. The tactile signal is provided to the tactile output apparatus 17.

The video output apparatus 15 includes a projector or the like, and displays a video corresponding to a video signal supplied from the transmission apparatus 14 on, for example, a screen provided in a live venue.

The audio output apparatus 16 includes a speaker or the like, and outputs audio corresponding to the audio signal supplied from the transmission apparatus 14.

The tactile output apparatus 17 includes a vibration presentation device worn on the performer's body, a microphone stand arranged in a stage, a vibration presentation device on a floor, and the like. The tactile output apparatus 17 generates, for example, vibration according to the tactile signal supplied from the transmission apparatus 14.

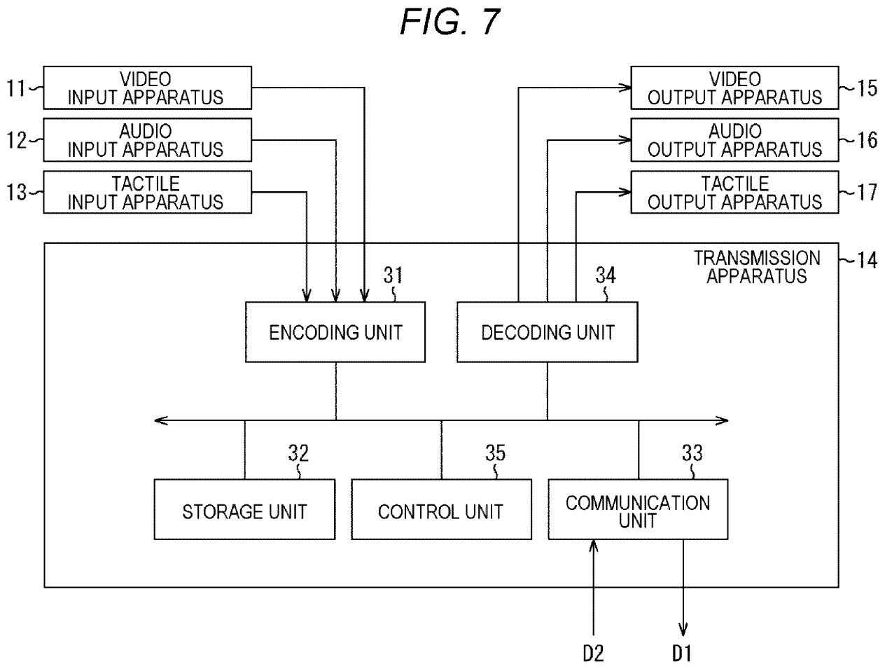

FIG. 7 is a block diagram illustrating a configuration example of the transmission apparatus 14.

As illustrated in FIG. 7, the transmission apparatus 14 is configured by connecting an encoding unit 31, a storage unit 32, a communication unit 33, a decoding unit 34, and a control unit 35 via a bus.

The encoding unit 31 acquires media signals supplied from the video input apparatus 11, the audio input apparatus 12, and the tactile input apparatus 13, performs encoding and multiplexing in an encoding format defined by a standard at regular time units, and supplies the performer data D1 to the communication unit 33 via the bus. Note that, as an example of the encoding format, for example, an MPEG4 Advanced Video Coding format is used for a video signal, and an MPEG4 Advanced Audio Coding format is used for an audio signal and a tactile signal.

The storage unit 32 includes, for example, a secondary storage device such as a hard disk drive (HDD) or a solid state drive (SSD), and stores coded data generated by encoding each media signal.

The communication unit 33 performs wired or wireless data communication with the server 1, transmits the performer data D1 generated by the encoding unit 31, receives the feedback data D2 transmitted from the server 1, and supplies the feedback data D2 to the decoding unit 34.

The decoding unit 34 performs demultiplexing and decoding in an encoding format defined by the standard on the feedback data D2 received by the communication unit 33, and acquires each media signal. The decoding unit 34 supplies the video signal to the video output apparatus 15, and supplies the audio signal to the audio output apparatus 16. The decoding unit 34 supplies the tactile signal to the tactile output apparatus 17.

The control unit 35 includes, for example, a microcomputer including a central processing unit (CPU), a read only memory (ROM), a random access memory (RAM), and the like, and performs processing according to a program stored in the ROM to control the entire transmission apparatus 14.

Note that, in a case where any of the input/output apparatuses is not provided as the environment of the live venue, the input/output of the media signal corresponding to the apparatus that is not provided may be ignored.

### 3. Configuration and Operation of Apparatus on Remote Audience Side

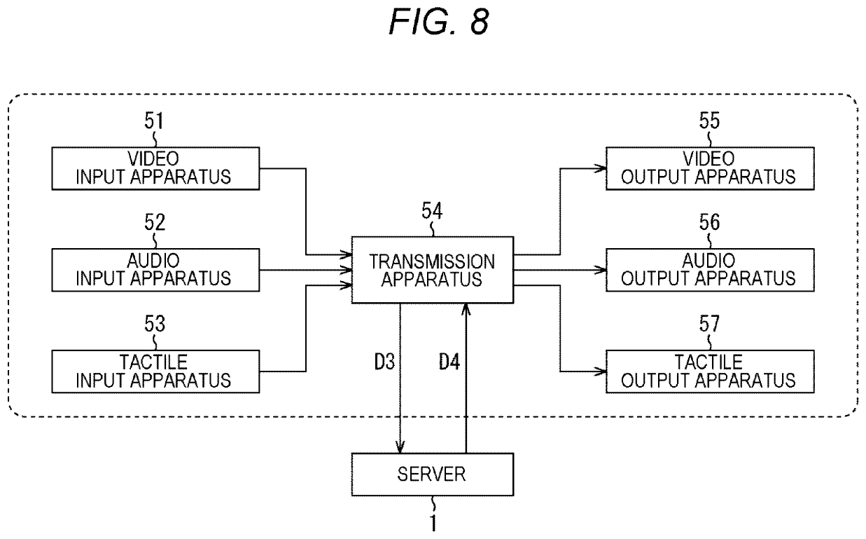

FIG. 8 is a diagram illustrating a configuration example of an apparatus used by a remote audience.

As illustrated in FIG. 8, a video input apparatus 51, an audio input apparatus 52, a tactile input apparatus 53, a transmission apparatus 54, a video output apparatus 55, an audio output apparatus 56, and a tactile output apparatus 57 are provided at a place where the remote audience participates in the remote live. The video input apparatus 51, the audio input apparatus 52, the tactile input apparatus 53, the video output apparatus 55, the audio output apparatus 56, and the tactile output apparatus 57 are connected to the transmission apparatus 54.

The remote audience participates in the remote live using an information terminal such as a smartphone, a PC, or a communication karaoke machine. The information terminal includes at least the transmission apparatus 54, and can further include any or all of the video input apparatus 51, the audio input apparatus 52, the tactile input apparatus 53, the video output apparatus 55, the audio output apparatus 56, and the tactile output apparatus 57.

The video input apparatus 51 includes a camera or the like built in the information terminal, and supplies a video signal obtained by capturing the face, movement state, and the like of the remote audience to the transmission apparatus 54.

The audio input apparatus 52 includes a microphone or the like built in the information terminal, and supplies an audio signal obtained by collecting the cheers, the fanchants, and the like of the remote audience to the transmission apparatus 54.

The tactile input apparatus 53 includes an acceleration sensor built in an information terminal, an acceleration sensor or a pressure sensor mounted on a penlight gripped by a remote audience, and the like. The tactile input apparatus 53 detects a tactile signal on the performer side indicating acceleration, pressure, and the like of the penlight, and supplies the tactile signal to the transmission apparatus 54.

The transmission apparatus 54 includes, for example, a microcomputer that communicates with the server 1. The transmission apparatus 54 transmits a data packet in a certain time unit obtained by encoding and multiplexing each media signal input from the video input apparatus 51, the audio input apparatus 52, and the tactile input apparatus 53 to the server 1 as audience data D3.

In addition, in parallel with the transmission of the audience data D3, the transmission apparatus 54 receives the distribution data D4 transmitted from the server 1, demultiplexes and decodes the distribution data D4, and acquires each media signal. The media signal on the performer side is synthesized with the media signal. The video signal is supplied to the video output apparatus 55, and the audio signal is supplied to the audio output apparatus 56. The tactile signal is provided to the tactile output apparatus 57.

The video output apparatus 55 includes a monitor of an information terminal, an external monitor connected to the information terminal, and the like, and displays a video corresponding to a video signal supplied from the transmission apparatus 54.

The audio output apparatus 56 includes a speaker of the information terminal, an external speaker connected to the information terminal, and the like, and outputs a voice corresponding to the audio signal supplied from the transmission apparatus 54.

The tactile output apparatus 57 includes an oscillator built in an information terminal or a penlight, a wearable device connected to the information terminal, a vibrator provided on a chair on which a remote audience sits, and the like. The tactile output apparatus 17 generates, for example, vibration according to the tactile signal supplied from the transmission apparatus 14.

Note that, in a case where any of the input/output apparatuses is not provided as an environment in which the remote audience participates in the remote live, input/output of the media signal corresponding to the apparatus that is not provided may be ignored.

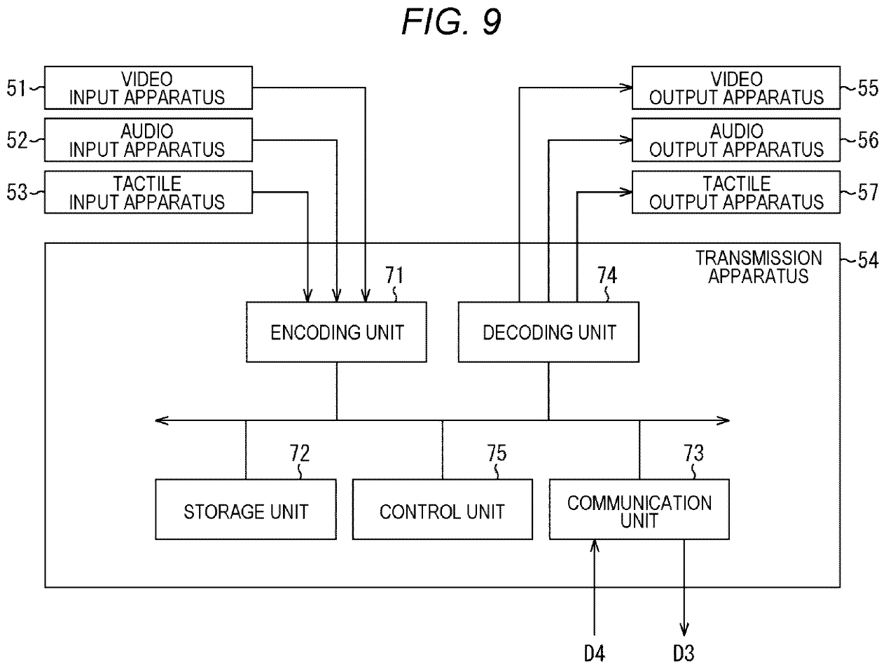

FIG. 9 is a block diagram illustrating a configuration example of the transmission apparatus 54.

As illustrated in FIG. 9, the transmission apparatus 54 is configured by connecting an encoding unit 71, a storage unit 72, a communication unit 73, a decoding unit 74, and a control unit 75 via a bus.

The encoding unit 71 acquires the media signals supplied from the video input apparatus 51, the audio input apparatus 52, and the tactile input apparatus 53, performs encoding and multiplexing in an encoding format defined by a standard at regular time units, and supplies the audience data D3 to the communication unit 73 via the bus. Note that, as the encoding format of each media signal, for example, the same encoding format as the encoding format of the media signal on the performer side is used.

The storage unit 72 includes, for example, a secondary storage device such as an HDD or an SSD, and stores coded data generated by encoding each media signal.

The communication unit 73 performs wireless data communication with the server 1, transmits the audience data D3 generated by the encoding unit 71, receives the distribution data D4 transmitted from the server 1, and supplies the distribution data D4 to the decoding unit 74.

The decoding unit 74 performs demultiplexing and decoding in an encoding format defined by the standard on the distribution data D4 received by the communication unit 73, and acquires each media signal. The decoding unit 74 supplies the video signal to the video output apparatus 55, and supplies the audio signal to the audio output apparatus 56. The decoding unit 74 supplies the tactile signal to the tactile output apparatus 57.

The control unit 75 includes, for example, a microcomputer including a CPU, a ROM, a RAM, and the like, and controls the entire transmission apparatus 54 by executing processing according to a program stored in the ROM.

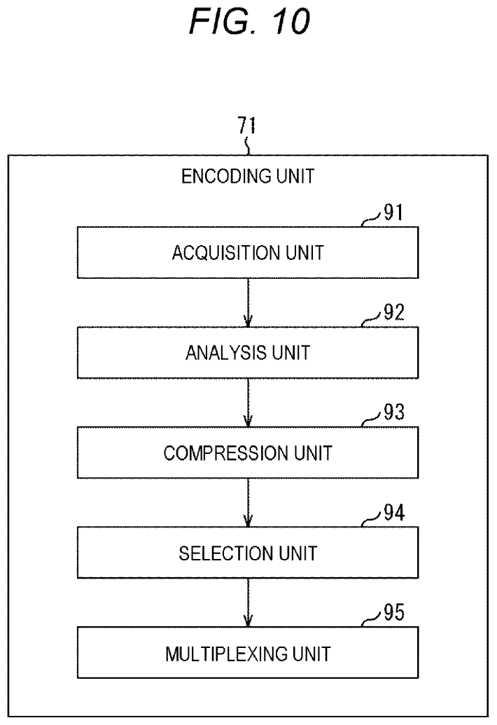

FIG. 10 is a block diagram illustrating a functional configuration example of the encoding unit 71.

As illustrated in FIG. 10, the encoding unit 71 includes an acquisition unit 91, an analysis unit 92, a compression unit 93, a selection unit 94, and a multiplexing unit 95.

The acquisition unit 91 acquires each of a video signal, an audio signal, and a tactile signal from the video input apparatus 51, the audio input apparatus 52, and the tactile input apparatus 53 as a signal for each prescribed time unit, and supplies the signal to the analysis unit 92.

The analysis unit 92 calculates the importance by a method defined for each media signal supplied from the acquisition unit 91.

Specifically, firstly, the analysis unit 92 calculates, as importance Iv of the video signal, a value obtained by normalizing the average value per pixel of the change amount of the luminance value from the previous frame to the current frame to a range of 0 to 1.0 as in the following equation (1).

$$[ Math . 1 ]$$

$${I}_{v} = \frac{1}{N \cdot 8} \sqrt{{\sum }_{k = 1}^{N} {( {X}_{k , t} - {X}_{k , t - 1} )}^{2}} \qquad ( 1 )$$

In Equation (1), X_{k,t} represents the luminance value of the k-th pixel in the current frame (time t), and X_{k,t-1} represents the luminance value of the k-th pixel in the previous frame (time t−1). N represents the total number of pixels, and B represents the absolute maximum value of the luminance value.

Secondly, the analysis unit 92 calculates the similarity between the voice indicated by the audio signal and the specific voice as the importance I_{A} of the audio signal. For example, the analysis unit 92 uses deep learning (DNN: Deep Neural Network) to acquire the similarity between the voice indicated by the audio signal and the voice of “fanchants”.

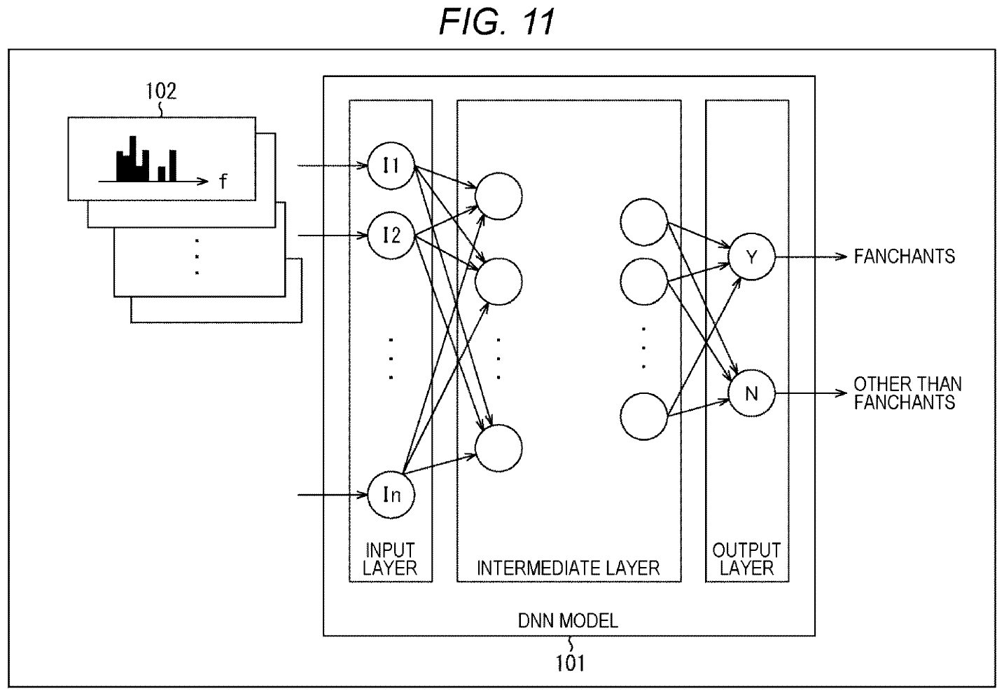

FIG. 11 is a diagram illustrating an example of a DNN learning method.

As illustrated in FIG. 11, the learning input data set 102 is input to the input layers I1 to In of the DNN model 101, whereby the DNN model 101 is learned.

Spectrum data of various audio signals to which a label indicating whether or not it is “fanchants” is added is collected in advance in a large amount as the learning input data set 102. The spectrum data is indicated by, for example, a normalized amplitude spectrum value for each frequency bin. The normalized amplitude spectrum value is input to the input layers I1 to In corresponding to the center frequency of each frequency bin.

At the time of learning of the DNN model 101, in a case where data to which a label indicating “fanchants” is added in the learning input data set 102 is input to the DNN model 101, the weight coefficient between each neuron of the intermediate layer (hidden layer) of the DNN model 101 is updated using the back propagation method (Backpropagation) so that the likelihood (probability) of “Y” of the output layer becomes higher than the likelihood of “N”.

Furthermore, in a case where data to which a label indicating that it is not the “fanchants” is added in the learning input data set 102 is input to the DNN model 101, the weight coefficient between each neuron in the intermediate layer of the DNN model 101 is updated using the back propagation method such that the likelihood of “N” of the output layer is higher than the likelihood of “Y”.

Learning is performed in advance by performing the above-described processing on all data included in the learning input data set 102. Note that the learned weight coefficient is recorded in client software used by the remote audience, and is saved in an information terminal used by the remote audience when the remote audience downloads the software.

The analysis unit 92 in FIG. 10 converts the audio signal of the current frame into a normalized amplitude spectrum and inputs the normalized amplitude spectrum to the DNN model 101. As a result, the evaluation value A1 indicating the likelihood of “Y” of the output layer of the DNN model 101 that detects “fanchants” is obtained. The evaluation value A1 indicates a likeness of a voice indicated by the audio signal as “fanchants”.

Furthermore, the analysis unit 92 acquires the evaluation value A2 indicating the likelihood of “Y” of the output layer of the DNN model by using the DNN model that detects “cheers” similar to the DNN model 101. The evaluation value A2 indicates a likeness of a voice indicated by the audio signal as “cheers”.

The analysis unit 92 associates the evaluation values A1 and A2 with weighting coefficients α (0≤α≤1.0) and 1.0−α, respectively, and calculates the importance I_{A} of the audio signal by linear combination of the evaluation values A1 and A2 as in the following equation (2).

$$[ Math . 2 ]$$

$${I}_{A} = A 1 \times α + A 2 \times ( 1. - α ) \qquad ( 2 )$$

Third, the analysis unit 92 calculates, as the importance I_{H} of the tactile signal, a strength or a change amount of at least one of pressure or acceleration indicated by the tactile signal.

For example, the analysis unit 92 associates the change amount of the normalized pressure value (0 to 1.0) from the previous frame to the current frame with the weighting coefficient β (0≤β≤1.0), and associates the change amount of the normalized acceleration value (0 to 1.0) from the previous frame to the current frame with the weighting coefficient 1.0−β. The analysis unit 92 calculates the importance I_{H} of the tactile signal by linear combination of the amount of change in the normalized pressure value and the amount of change in the normalized acceleration value as in the following equation (3).

$$[ Math . 3 ]$$

$${I}_{H} = \vert {h}_{t}^{1} {h}_{t - 1}^{1} \vert \cdot β + \vert {h}_{t}^{2} - {h}_{t - 1}^{2} \vert \cdot ( 1. - β ) \qquad ( 3 )$$

In Equation (3), h¹ₜ represents the normalized pressure value in the current frame (time t), and h¹ₜ₋₁ represents the normalized pressure value in the previous frame (time t−1). In addition, h²ₜ represents a normalized acceleration value in the current frame (time t), and h²ₜ₋₁ represents a normalized acceleration value in the previous frame (time t−1).

The analysis unit 92 supplies the information indicating the importance of each media signal calculated as described above and each media signal to the compression unit 93.

The compression unit 93 performs data compression by encoding the media signal supplied from the analysis unit 92 in a prescribed encoding format for each type, and supplies the obtained coded data and information indicating the importance of each media signal to the selection unit 94.

The selection unit 94 selects data to be transmitted among the coded data generated by the compression unit 93 on the basis of the importance calculated by the analysis unit 92. Specifically, the selection unit 94 determines the priority order of each coded data, and determines whether or not to transmit each coded data at that timing.

The coded data that has not been transmitted is stored in a remaining buffer provided in the storage unit 72. The coded data stored in the remaining buffer is discarded according to the data transmission status by the communication unit 73. Note that details of the priority order determination method and the method of determining whether or not to transmit will be described later.

The multiplexing unit 95 generates the audience data D3 by multiplexing the coded data selected as the transmission target by the selection unit 94. Note that, as a format of the audience data D3, for example, an MPEG4 container, an MPEG2-TS (MPEG2 transport stream), or the like can be considered.

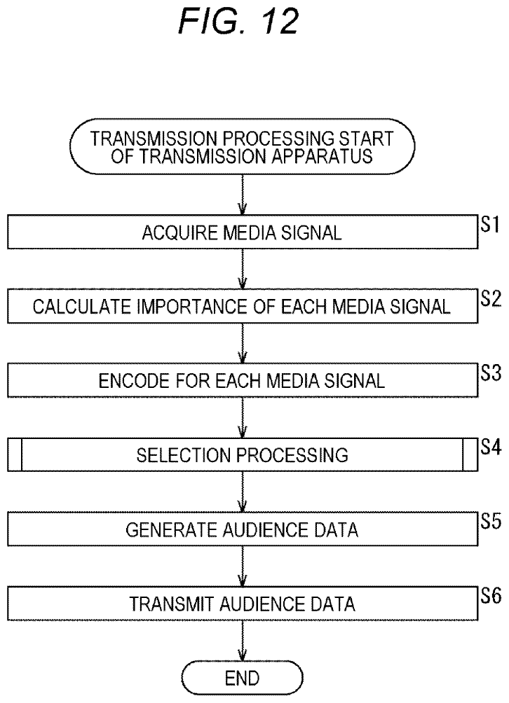

Next, transmission processing performed by the transmission apparatus 54 having the above-described configuration will be described with reference to a flowchart in FIG. 12.

In step S1, the acquisition unit 91 acquires a media signal from each of the video input apparatus 51, the audio input apparatus 52, and the tactile input apparatus 53.

In step S2, the analysis unit 92 calculates the importance of each media signal.

In step S3, the compression unit 93 encodes the media signal in a prescribed encoding format for each type, and generates coded data.

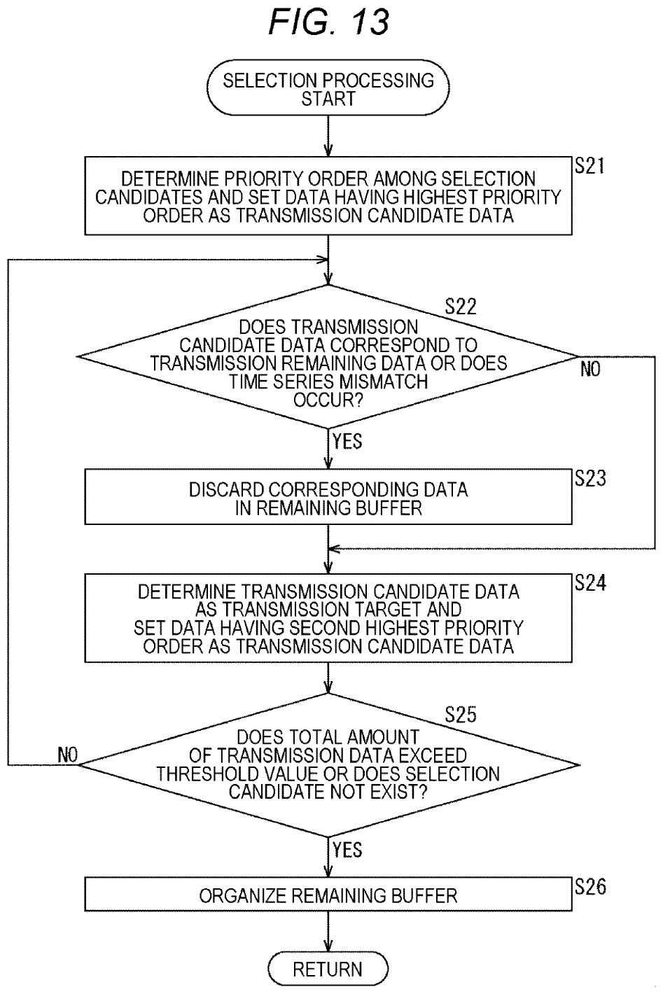

In step S4, the selection unit 94 performs selection processing. Through the selection processing, data to be transmitted among the coded data is selected on the basis of the importance of each media signal. Details of the selection processing will be described later with reference to FIG. 13.

In step S5, the multiplexing unit 95 generates the audience data D3 by multiplexing the coded data selected as the transmission target.

In step S6, the communication unit 73 transmits the audience data D3 to the server 1.

The selection processing performed in step S4 of FIG. 12 will be described with reference to the flowchart of FIG. 13.

In step S21, the selection unit 94 sets the coded data obtained by encoding each media signal of the current frame and the transmission remaining data as selection candidates. The transmission remaining data is coded data that is not transmitted until the previous frame and is stored in the remaining buffer. The selection unit 94 determines the priority order of the coded data in the selection candidates in descending order of importance of each media signal, and sets the coded data having the highest priority as the transmission candidate data.

In step S22, the selection unit 94 determines whether or not the transmission candidate data corresponds to the transmission remaining data or whether or not the time series mismatch occurs when the transmission candidate data is selected as the transmission target.

In a case where the transmission candidate data corresponds to the transmission remaining data or in a case where the time series mismatch occurs, the process proceeds to step S23. For example, in a case where coded data obtained by encoding a media signal of the same type as the type of the transmission candidate data is stored in the remaining buffer as transmission remaining data, it is determined that time series mismatch occurs.

In step S23, the selection unit 94 discards the corresponding data in the remaining buffer. Specifically, in a case where the transmission candidate data corresponds to the transmission remaining data, the selection unit 94 discards the transmission remaining data set as the transmission candidate data from the remaining buffer.

In addition, in a case where the time series mismatch occurs, the selection unit 94 discards the transmission remaining data obtained by encoding the media signal of the same type as the type of the transmission candidate data from the remaining buffer. As a result, it is possible to prevent occurrence of time series mismatch in which coded data obtained by encoding a media signal acquired in a frame before the transmission candidate data is transmitted to the server 1 after the transmission candidate data is transmitted to the server 1.

On the other hand, in a case where the transmission candidate data does not correspond to the transmission remaining data and the time series mismatch does not occur, step S23 is skipped, and the process proceeds to step S24.

In step S24, the selection unit 94 finally determines the transmission candidate data as the transmission target, and sets the data having the second highest priority order in the selection candidates as the transmission candidate data.

Note that, in a case where coded data is delayed until the next or subsequent frame and transmitted, or in a case where a defect occurs in time-series data, a discontinuous point of a media signal occurs, and there is a possibility that a sense of discomfort of experience for a remote audience or the like occurs. In order to avoid this, the communication unit 73 adds 1-bit flag information (discontinuous point flag) to the header information portion of the audience data of the frame immediately after the occurrence of the delay or the loss, and notifies the server 1 that the delay or the loss has occurred.

The server 1 interprets that there is no discontinuous point in a case where the discontinuous point flag is “0”, and interprets that there is a discontinuous point in a case where the discontinuous point flag is “1”. The process of smoothing the discontinuous point of the media signal by the server 1 will be described later.

In step S25, the selection unit 94 determines whether or not the total amount of the coded data selected as the transmission target (total amount of transmission data) exceeds a prescribed threshold value or there is no selection candidate.

In a case where the total amount of transmission data does not exceed the prescribed threshold value and there is a selection candidate, the process returns to step S22, and the subsequent processes are performed. That is, the selection unit 94 continues to select the transmission target coded data from the selection candidates until the total data amount exceeds the threshold value or there is no selection candidate.

Note that it is conceivable that the threshold value for the total amount of transmission data is a value determined in advance by a software designer or an administrator of a remote live system, but may be a value that dynamically changes depending on the communication status of each remote audience. For example, in a case where the communication status is good, it is possible to transmit as many media signals as possible by increasing the threshold value. On the other hand, in a case where the communication status is poor, it is possible to transmit the minimum media signal that enables experience without a sense of discomfort by decreasing the threshold value.

In a case where the total amount of transmission data exceeds the threshold value or there is no selection candidate, the process proceeds to step S26.

In step S26, the selection unit 94 organizes the remaining buffers. Specifically, the selection unit 94 stores all the coded data of the selection candidate that has not been selected as the transmission target in the remaining buffer. In a case where transmission remaining data obtained by encoding the same type of media signal is stored equal to or more than a prescribed threshold value, old coded data may be discarded. Here, the prescribed threshold value may be a different value depending on the type of the media signal.

After the remaining buffers are organized, the process returns to step S4 in FIG. 12, and the subsequent processes are performed.

In the above transmission processing, the media signal (coded data) to be transmitted is selected on the basis of the context information indicating the importance of each media signal. Therefore, in the information terminal used by the remote audience, a media signal in which low delay reproduction is visually, audibly, and tactilely important is preferentially transmitted according to a scene, and a media signal that is not important is transmitted with a delay or discarded.

As a result, the time until the audience data D3 is received in the server 1 can be set short, and the delay in communication of the entire remote live system can be reduced. Therefore, it is possible to realize a low-delay remote live experience while maintaining the quality of the experience to such an extent that there is no sense of discomfort.

### 4. Configuration and Operation of Server

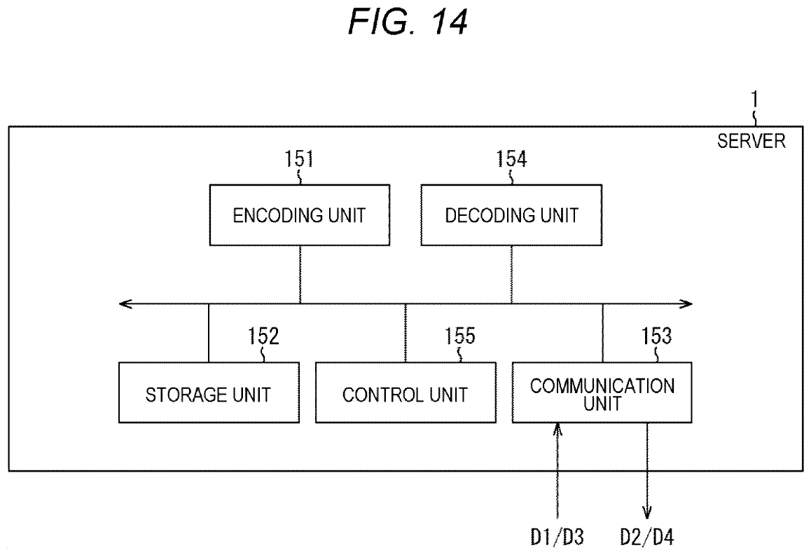

FIG. 14 is a block diagram illustrating a configuration example of the server 1.

As illustrated in FIG. 14, the server 1 is configured by connecting an encoding unit 151, a storage unit 152, a communication unit 153, a decoding unit 154, and a control unit 155 via a bus.

The encoding unit 151 synthesizes the media signal of the performer side and the media signal of the remote audience side acquired by the decoding unit 154 for each type, and encodes and multiplexes the synthesized signals in an encoding format defined by a standard. The encoding unit 151 supplies the feedback data D2 and the distribution data D4 generated by multiplexing to the communication unit 153 via the bus. Note that, as the encoding format of each media signal, for example, the same encoding format as the encoding format of the media signal on the performer side or the media signal on the remote audience side is used.

The storage unit 152 includes, for example, a secondary storage device such as an HDD or an SSD, and stores coded data obtained by encoding each media signal.

The communication unit 153 performs wired or wireless data communication with the transmission apparatus 14, transmits the feedback data D2 generated by the encoding unit 151, receives the performer data D1 transmitted from the transmission apparatus 14, and supplies the performer data D1 to the decoding unit 154.

Furthermore, the communication unit 153 performs wireless data communication with the transmission apparatus 54, transmits the distribution data D4 generated by the encoding unit 151, receives the audience data D3 transmitted from the transmission apparatus 54, and supplies the audience data D3 to the decoding unit 154.

Note that, in the following description, the total number of remote audiences is denoted by N. It is assumed that audience data to be transmission sources of the remote audience 1 to N is D3₁ to D3_{N}, and distribution data to be transmission destinations of the remote audience 1 to N is D4₁ to D4_{N}. It is assumed that the media signals on the remote audience side acquired from the audience data D3₁ to D3_{N} are SD3₁ to SD3_{N}, and the media signals for the remote audience acquired from the distribution data D4₁ to D4_{N} are SD4₁ to SD4_{N}.

Hereinafter, in a case where it is not necessary to individually distinguish the media signals SD3₁ to SD3_{N} on the remote audience side, they are simply referred to as media signals SD3. It similarly applies to the media signals SD4₁ to SD4_{N}, the video signals SD3V₁ to SD3V_{N}, the audio signals SD3A₁ to SD3A_{N}, the tactile signals SD3H₁ to SD3H_{N}, the video signals SD4V₁ to SD4V_{N}, the audio signals SD4A₁ to SD4A_{N}, and the tactile signals SD4H₁ to SD4H_{N} described later.

Furthermore, video signals on the remote audience side included in the media signals SD3₁ to SD3_{N} on the remote audience side are denoted by SD3V₁ to SD3V_{N}, audio signals on the remote audience side are denoted by SD3A₁ to SD3A_{N}, and tactile signals on the remote audience side are denoted by SD3H₁ to SD3H_{N}. It is assumed that video signals for remote audience included in media signals SD4₁ to SD4_{N} for remote audience are SD4V₁ to SD4V_{N}, audio signals for remote audience are SD4A₁ to SD4A_{N}, and tactile signals for remote audience are SD4H₁ to SD4H_{N}.

Similarly, a media signal on the performer side acquired from the performer data D1 is SD1, and a media signal for the performer acquired from the feedback data D2 is SD2. A video signal on the performer side included in the media signal SD1 on the performer side is SD1V, an audio signal on the performer side is SD1A, and a tactile signal on the performer side is SD1H. A video signal for the performer included in the media signal SD2 for the performer is SD2V, an audio signal for the performer is SD2A, and a tactile signal for the performer is SD2H.

The decoding unit 154 performs demultiplexing and decoding in an encoding format defined by the standard on the performer data D1 received by the communication unit 153 to acquire a media signal SD1 on the performer side. Furthermore, the decoding unit 154 performs demultiplexing and decoding in an encoding format defined by the standard on the audience data D3₁ to D3_{N} received by the communication unit 153, and acquires the media signals SD3₁ to SD3_{N} on the remote audience side.

The decoding unit 154 supplies the acquired media signal SD1 of the performer side and the acquired media signals SD3₁ to SD3_{N} of the remote audience side to the encoding unit 151.

The control unit 155 includes, for example, a microcomputer including a CPU, a ROM, a RAM, and the like, and controls the entire server 1 by executing processing according to a program stored in the ROM.

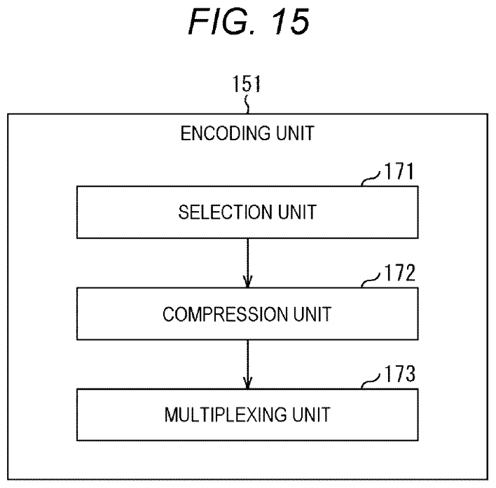

FIG. 15 is a block diagram illustrating a configuration example of the encoding unit 151.

As illustrated in FIG. 15, the encoding unit 151 includes a selection unit 171, a compression unit 172, and a multiplexing unit 173.

The media signal SD1 of the performer side and the media signals SD3₁ to SD3_{N} of the respective remote audience sides are input to the selection unit 171. The selection unit 171 selects a signal to be incorporated into the media signal SD2 for the performer and a signal to be incorporated into the media signal SD4 for each remote audience from among the media signal SD1 on the performer side and the media signals SD3₁ to SD3_{N} on each remote audience side, and synthesize (mixes) the signals. In other words, the selection unit 171 selects a media signal for a performer and a remote audience to be transmitted.

Note that media signals on the remote audience side that have not been transmitted within the prescribed time due to the communication status are excluded from candidates for synthesis.

The following three cases are conceivable as cases of synthesizing a media signal for a performer and a media signal for a remote audience.
Case 1: Case of generating the same media signal (one pattern) for performers and for all remote audience
Case 2: Case of generating different media signals (two patterns) for performers and for all remote audience
Case 3: Case of generating different media signals (N+1 patterns) for each performer and each remote audience.

Processing of the selection unit 171 will be described for each of cases 1 to 3.

### (Case 1)

In Case 1, the media signal SD2 for the performer and the media signal SD4 for all remote audience have the same content.

For example, the selection unit 171 generates a signal indicating a video in which a video in which the face or the state of support of the remote audience is imaged is superimposed as a wipe on a video of performance or acting of a main performer as a video signal for the performer and each remote audience. Here, the screen occupancy of the main video increases, and the screen occupancy of the wipe video decreases.

In a case where the number of remote audiences is relatively small, it is also possible to fix the video of all the remote audiences in a certain size in the screen and superimpose the fixed video on the main video. Furthermore, in a case where there are many remote audiences or in consideration of production or the like, it is also possible to superimpose a video of only one randomly picked up remote audience on the main video.

Furthermore, for example, the selection unit 171 generates a signal indicating a voice in which a voice in which a cheer, a call, a clapping, a fanchant, and the like of all the remote audiences are collected is superimposed on a voice of a performer's performance or a speech as an audio signal for the performer and each remote audience.

It is also possible to superimpose each voice after adjusting the volume balance between the voice of the performer and the voice of all the remote audiences. Furthermore, in order to prevent sound breakup (clipping), it is also possible to reduce the volume of each sound and then superimpose the sound.

Since it is difficult to synthesize the tactile signal on the performer side and the tactile signal for all the remote audiences, the selection unit 171 uses the tactile signal on the performer side as the tactile signal for the performer and each remote audience. In this case, the tactile signal for the performer is muted on the live venue side, for example, so that vibration or the like indicated by the tactile signal on the performer side is not presented to the performer.

### (Case 2)

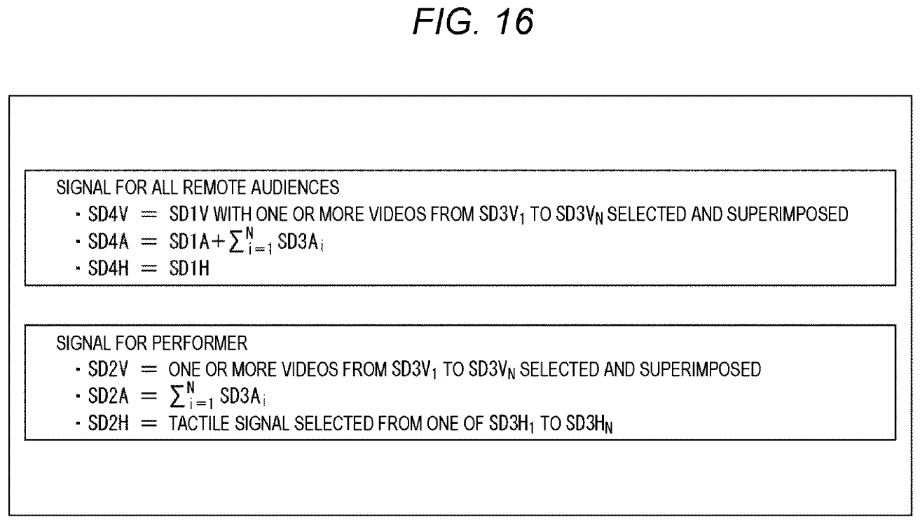

FIG. 16 is a diagram illustrating an example of a media signal for a performer and a media signal for a remote audience in Case 2.

In Case 1, since only one pattern of media signals needs to be generated, the load on the server 1 is reduced, but the media signals for the performers include media signals such as videos of the performers themselves. For this reason, there is a risk that redundancy or a sense of discomfort may occur to the performer. It is considered that the performer does not need to confirm his/her own video, voice, vibration, and the like on a screen or the like in a live venue, and it is sufficient that the performer can confirm the reaction of the remote audience.

Therefore, in Case 2, as illustrated in the upper part of FIG. 16, the selection unit 171 generates a signal obtained by selecting and superimposing one or more video signals among the video signals SD3V₁ to SD3V_{N} of each remote audience with respect to the video signal SD1V of the performer side as the video signal SD4V for all remote audience.

The selection unit 171 generates a signal in which the audio signals of the audio signals SD3A₁ to SD3A_{N} of all the remote audiences are superimposed on the audio signal SD1A of the performer side as the audio signal SD4A for all the remote audiences.

The selection unit 171 selects the tactile signal SD1H on the performer side as the tactile signal SD4H for all remote audience.

Note that the content of the media signal SD4 for all remote audience in Case 2 is the same as the content of the media signal SD4 for all remote audience in Case 1 described above.

Furthermore, as illustrated in the lower part of FIG. 16, the selection unit 171 generates a signal obtained by selecting and superimposing one or more video signals among the video signals SD3V₁ to SD3V_{N} of each remote audience side as the video signal SD2V for the performer.

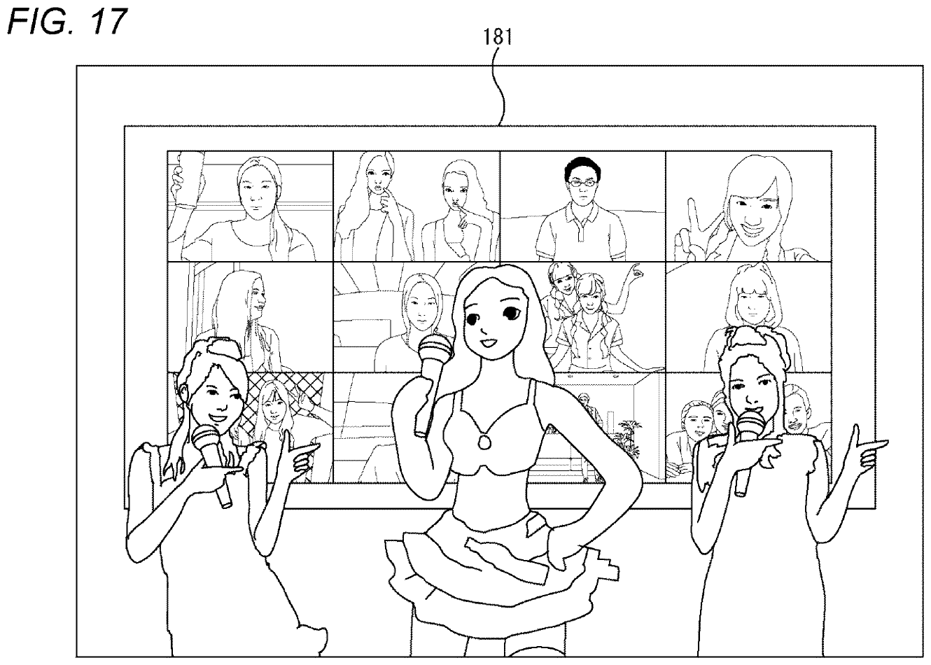

In this case, in the live venue, as illustrated in FIG. 17, the videos of the respective remote audiences are displayed side by side in a tile shape on a screen 181 installed on the back side of the three performers, for example.

Returning to FIG. 16, the selection unit 171 generates signals on which the audio signals of the audio signals SD3A₁ to SD3A_{N} of all the remote audience sides are superimposed as the audio signal SD2A for the performer.

Since it is considered that there is a high possibility that a sense of discomfort occurs when vibrations of a plurality of remote audiences are synthesized and presented at the live venue at the same time, the selection unit 171 selects one tactile signal of the tactile signals SD3H₁ to SD3H_{N} of each remote audience side as the tactile signal SD2H for the performer. For example, one tactile signal is selected according to a lottery result or importance. Note that it is also possible to superimpose two or more tactile signals to generate the tactile signal SD2H for the performer.

### (Case 3)

In Case 2, the media signal for each remote audience includes a media signal such as a video signal of the remote audience itself. For this reason, there is a risk that redundancy or a sense of discomfort may occur to the remote audience. Each remote audience does not need to confirm its own video, voice, vibration, and the like, and it is sufficient that each remote audience can confirm a reaction between the performer and a remote audience other than itself.

Furthermore, as an important element in the live experience, there is a sense of unity and communication with other audiences. It is considered that the audience wants to grasp the state of the friend with which the audience is in close association (facial expression, cheers, body contact, or the like) in more detail than the states of the other audience. In addition, it is natural that the audience can grasp the state of another audience who is not a friend but is nearby in more detail than the state of another audience who is far away.

Therefore, in Case 3, the selection unit 171 mixes the media signals of the remote audience side of the transmission source with a mixing ratio according to the degree of relationship between the remote audience of the transmission source and the remote audience of the transmission destination. This generates a media signal for each remote audience. Assuming that j is the remote audience at the transmission destination and k is the remote audience at the transmission source, the degree of relationship R_{j,k} is expressed by the following equation (4).

$$[ Math . 4 ]$$

$${R}_{j , k} = {F}_{j , k} \times δ + {C}_{j , k} \cdot ( 1. - δ ) \qquad ( 4 )$$

In Equation (4), F_{j,k} is the degree of intimacy between the remote audience j and the remote audience k, and C_{j,k} is the degree of proximity between the remote audience j and the remote audience k.

The degree of intimacy F_{j,k} is an index indicating an amicable relationship (psychological distance) between remote audiences, and is set as a value in a range of 0 to 1.0. For example, as the degree of intimacy F_{j,k}, 0 is set in advance for the remote audience j in a case where the remote audience k is another person, and 0.5 is set in advance for the remote audience j in a case where the remote audience k is a person who knows each other. In a case where the remote audience k is the closest to the remote audience j, 1.0 is set in advance as the degree of intimacy F_{j,k}.

The degree of proximity C_{j,k} is an index indicating positional relationship (distance) between remote audiences in a virtual live venue, and is set as a value in a range of 0 to 1.0. For example, as the degree of proximity C_{j,k}, 1.0 is set in a case where the seats of the remote audience j and the remote audience k in the live venue are adjacent, and a value (minimum 0) obtained by subtracting 0.1 for each seat away is set.

Note that, in a case where the remote audience can move in the virtual space, such as virtual reality (VR) remote live, the degree of proximity C_{j,k} can be changed according to the movement of the remote audience.

As illustrated in Equation (4), the degree of relationship R_{j,k} is calculated by a linear combination of the degree of intimacy F_{j,k} and the degree of proximity C_{j,k} with which the weighting coefficients δ (0≤δ≤1.0) and 1.0−δ are associated, respectively, and has a value in a range of 0 to 1.0. The degree of relationship R_{j,k} is stored and managed by the server 1 in association with each remote audience.

The weighting coefficient δ is a parameter for determining the balance between the degree of intimacy and the degree of proximity, and is determined in advance by a software designer or an administrator of a remote live system. It is also possible for each remote audience to freely change the weighting coefficient δ according to their preference.

Note that details of a method of generating a media signal for each remote audience according to the degree of relationship R_{j,k} will be described later. Further, the media signal SD2 for the performer in Case 3 is similar to that in Case 2, and thus the description thereof will be omitted.

Returning to FIG. 15, the selection unit 171 supplies the generated media signals SD4₁ to SD4_{N} for each remote audience and the generated media signal SD2 for the performer to the compression unit 172.

The compression unit 172 performs data compression by encoding each of the media signals SD4₁ to SD4_{N}, SD2 supplied from the selection unit 171 using a prescribed encoding format for each type, and supplies the obtained coded data to the multiplexing unit 173.

The multiplexing unit 173 generates the distribution data D4₁ to D4_{N} by multiplexing the coded data obtained by encoding the media signals SD4₁ to SD4_{N} supplied from the compression unit 172. Furthermore, the multiplexing unit 173 generates the feedback data D2 by multiplexing the coded data obtained by encoding the media signal SD2 supplied from the compression unit 172. Note that, as formats of the distribution data D4₁ to D4_{N} and the feedback data D2, for example, an MPEG4 container, MPEG2-TS, or the like can be considered.

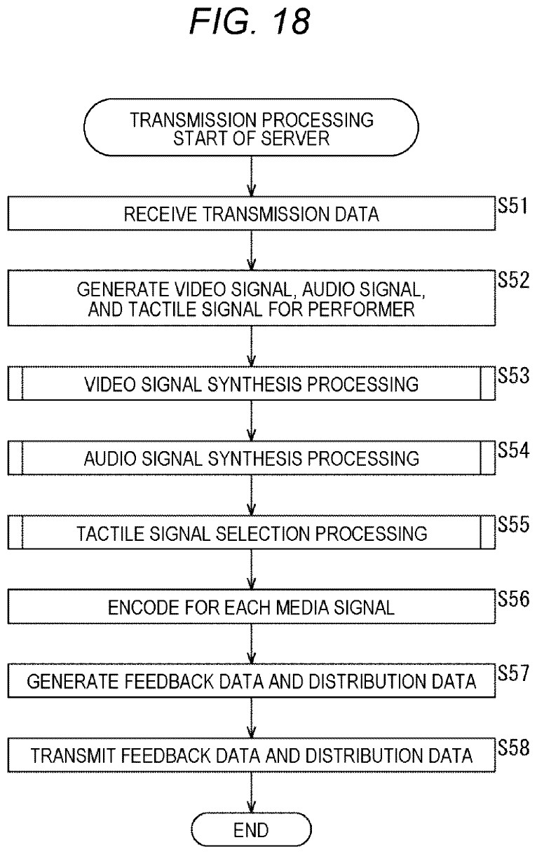

The transmission processing performed by the server 1 having the above configuration will be described with reference to the flowchart of FIG. 18. In FIG. 18, a process performed in Case 3 in which different media signals (N+1 patterns) are generated for each performer and each remote audience will be described.

In step S51, the communication unit 153 receives the performer data transmitted from the transmission apparatus 14 and the audience data transmitted from the transmission apparatus 54.

In step S52, the selection unit 171 generates a video signal, an audio signal, and a tactile signal for the performer.

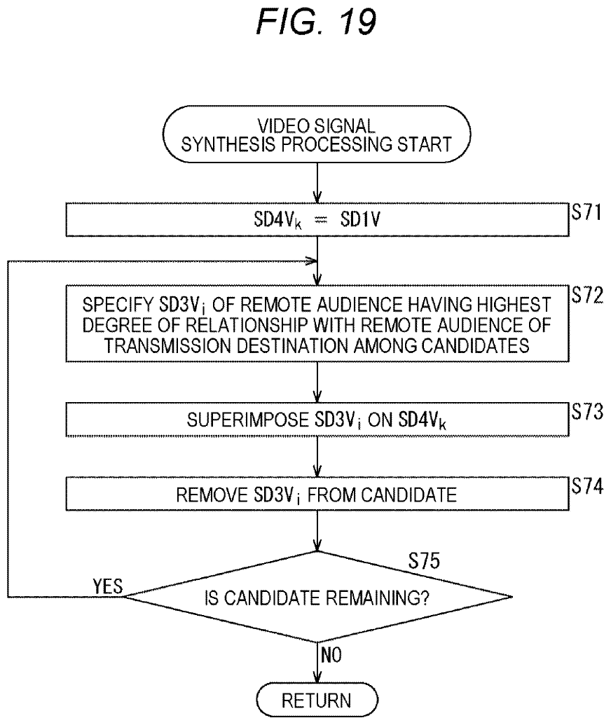

In step S53, the selection unit 171 performs video signal synthesis processing. By the video signal synthesis processing, a video signal for each remote audience is generated on the basis of the degree of relationship R_{j,k}. Details of the video signal synthesis processing will be described later with reference to FIG. 19.

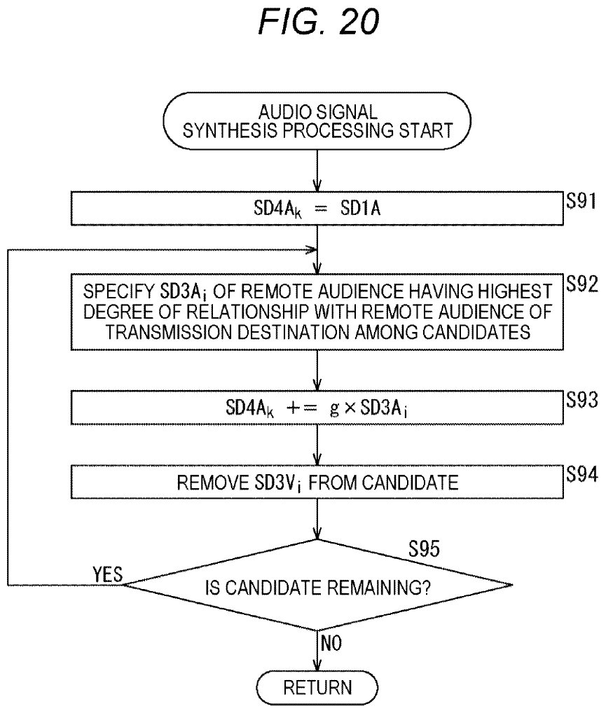

In step S54, the selection unit 171 performs audio signal synthesis processing. By the audio signal synthesis processing, an audio signal for each remote audience is generated on the basis of the degree of relationship R_{j,k}. Details of the audio signal synthesis processing will be described later with reference to FIG. 20.

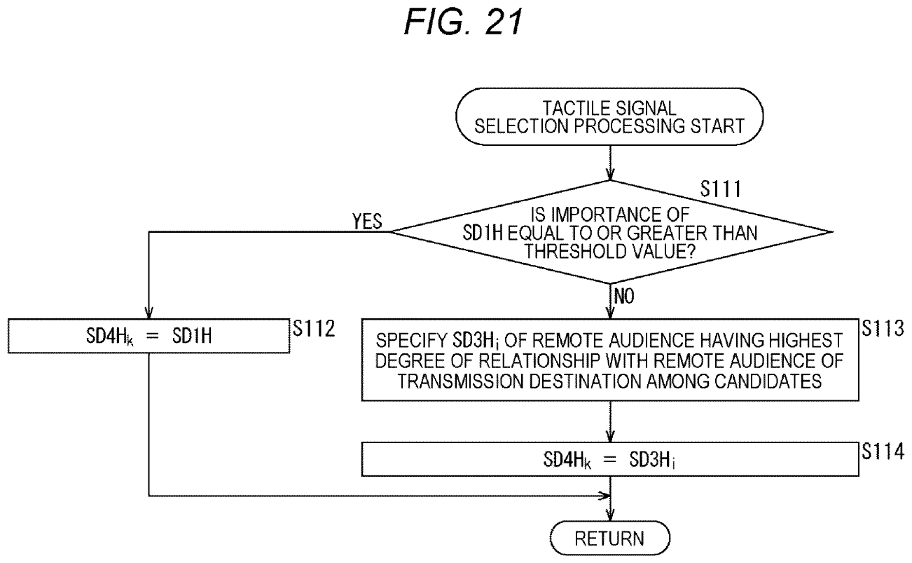

In step S55, the selection unit 171 performs tactile signal selection processing. By the tactile signal selection processing, a tactile signal for each remote audience is selected on the basis of the degree of relationship R_{j,k}. Details of the tactile signal selection processing will be described later with reference to FIG. 21.

In step S56, the compression unit 172 encodes the media signal in a prescribed encoding format for each type, and generates coded data.

In step S57, the multiplexing unit 173 generates feedback data by multiplexing coded data obtained by encoding media signals for performers, and generates distribution data by multiplexing coded data obtained by encoding media signals for each remote audience.

In step S58, the communication unit 153 transmits the feedback data to the transmission apparatus 14 and transmits the distribution data to the transmission apparatus 54.

The video signal synthesis processing performed in step S53 of FIG. 18 will be described with reference to the flowchart of FIG. 19.

In step S71, the selection unit 171 loads the video signal SD1V on the performer side, and uses the video signal SD1V as a base of the video signal SD4Vₖ for the remote audience k of the transmission destination.

In step S72, the selection unit 171 specifies the video signal SD3Vᵢ on the side of the remote audience i having the highest degree of relationship R_{k,i} with the remote audience k of the transmission destination among the synthesis candidates.

For example, among the video signals SD3V₁ to SD3V_{N} on the remote audience side, a video signal that has arrived at the server 1 and has a higher degree of relationship with the remote audience k of the transmission destination than a prescribed threshold value is set as a synthesis candidate. Video signals for a predetermined number of people may be selected as synthesis candidates in descending order of the degree of relationship with the remote audience k of the transmission destination.

In step S73, the selection unit 171 superimposes the video signal SD3Vᵢ of the remote audience i side on the video signal SD4Vₖ. Note that the occupancy of the video indicated by the video signal SD1V in the screen of the video indicated by the video signal SD4Vₖ for the remote audience k may be set according to the degree of relationship R_{k,i}.

In step S74, the selection unit 171 removes the video signal SD3Vᵢ from the synthesis candidate.

In step S75, the selection unit 171 determines whether or not a synthesis candidate remains.

In a case where it is determined in step S75 that a synthesis candidate remains, the process returns to step S72, and the subsequent processing is performed.

On the other hand, in a case where it is determined in step S75 that no synthesis candidate remains, the video signal SD4Vₖ for the remote audience k of the transmission destination is completed. Thereafter, the process returns to step S53 in FIG. 18, and the subsequent processing is performed.

As described above, by synthesizing video signals according to the priority order determined on the basis of the degree of relationship, it is possible to present, to the remote audience, a video of only another remote audience having a friendship with the remote audience of the transmission destination or another remote audience in proximity.

For example, in a case of realizing a remote live of a mechanism of superimposing a real object on a VR space, it is possible to display only a remote audience having a friendship with a remote audience of a transmission destination or a remote audience in proximity as a real object, and to render the other remote audience by simple computer graphics (CG).

In this case, it is possible to save resources of the entire remote live system while providing a remote live experience without a sense of discomfort to the remote audience. Note that smoothing may be performed to smooth the boundary between the real object and the CG.

The audio signal synthesis processing performed in step S54 in FIG. 18 will be described with reference to the flowchart in FIG. 20.

In step S91, the selection unit 171 loads the audio signal SD1A on the performer side, and uses the audio signal SD1A as a base of the audio signal SD4Aₖ for the remote audience k of the transmission destination. Furthermore, the selection unit 171 sets the gain coefficient g for addition of the audio signal of the remote audience side to, for example, 1.0.

In step S92, the selection unit 171 sets the audio signal that has arrived at the server 1 among the audio signals SD3A₁ to SD3A_{N} of the respective remote audience sides as a synthesis candidate, and specifies the audio signal SD3Aᵢ of the remote audience i side having the highest degree of relationship R_{k,i} with the remote audience k of the transmission destination among the synthesis candidates.

In step S93, the selection unit 171 adds a signal obtained by multiplying the audio signal SD3Aᵢ by the gain coefficient g to the audio signal SD4Aₖ. Thereafter, the selection unit 171 subtracts a prescribed numerical value (for example, 0.1) from the gain coefficient g.

In step S94, the selection unit 171 removes the audio signal SD3Aᵢ from the synthesis candidate.

In step S95, the selection unit 171 determines whether or not a synthesis candidate remains.

In a case where it is determined in step S95 that a synthesis candidate remains, the process returns to step S92, and the subsequent processing is performed.

On the other hand, in a case where it is determined in step S95 that no synthesis candidate remains, the audio signal SD4Aₖ for the remote audience k of the transmission destination is completed. Thereafter, the process returns to step S54 in FIG. 18, and the subsequent processing is performed.

As described above, by synthesizing the voice multiplied by the gain coefficient g determined on the basis of the degree of relationship, it is possible to present, to the remote audience of the transmission destination, a voice in which the voice of the remote audience having a friendship with the remote audience of the transmission destination or the remote audience at a close position is heard larger and the voice of the other remote audience is heard smaller. This makes it possible to provide a remote live experience without a sense of discomfort to the remote audience.

The tactile signal selection processing performed in step S55 in FIG. 18 will be described with reference to the flowchart in FIG. 21.

In step S111, the selection unit 171 calculates the importance I_{H} of the tactile signal SD1H on the performer side, and determines whether or not the importance I_{H} is equal to or greater than a prescribed threshold value.

In a case where it is determined in step S111 that the importance I_{H} is equal to or greater than the prescribed threshold value, the process proceeds to step S112. In step S112, the selection unit 171 selects the tactile signal SD1H on the performer side as the tactile signal SD4Hₖ for the remote audience k.

On the other hand, in a case where it is determined in step S111 that the importance I_{H} is less than the prescribed threshold value, the process proceeds to step S113. In step S113, the selection unit 171 sets the tactile signal that has arrived at the server 1 among the tactile signals SD3H₁ to SD3H_{N} of each remote audience side as a selection candidate, and specifies the tactile signal SD3Hᵢ of the remote audience i side having the highest degree of relationship R_{k,i} with the remote audience k among the selection candidates.

In step S114, the selection unit 171 selects the tactile signal SD3Hᵢ on the remote audience i side as the tactile signal SD4Hₖ for the remote audience k.

After the tactile signal SD4Hₖ for the remote audience k is selected in step S112 or step S114, the process returns to step S55 in FIG. 18, and the subsequent processes are performed.

By performing the tactile signal selection processing, in a case where the tactile signal on the performer side has some meaning, such as the performer side shaking hands or stepping, or the vibration of the musical instrument on the performer side being indicated by the tactile signal, the vibration indicated by the tactile signal on the performer side or the like can be presented to the remote audience. Furthermore, in a case where the tactile signal on the performer side is meaningless, gripping of a penlight, intensity of swing, and the like indicated by the tactile signal on the other remote audience side having a high relationship with the remote audience at the transmission destination can be preferentially presented to the remote audience at the transmission destination.

As described above, in the server 1, not all the media signals on the side of the remote audience are treated equally, but the media signal of the transmission target is selected in consideration of the context information indicating the degree of relationship (importance of relationship) between the remote audience of the transmission destination and the remote audience of the transmission source.

By preferentially transmitting a media signal that is important to each remote audience and discarding a media signal that is not important, the time until the server 1 transmits distribution data can be set short. As a result, it is possible to reduce the delay in communication of the entire remote live system while maintaining the quality of the experience to such an extent that there is no sense of discomfort.

### 5. Modification

### About Smoothing Processing

The smoothing processing in which the server 1 smooths the discontinuous point of the media signal will be described. When decoding the audience data, the decoding unit 154 of the server 1 decodes the discontinuous point flag indicating the presence or absence of delay or discard added to the header information portion of the audience data. In a case where the value of the discontinuous flag added to the audience data is “1”, and in a case where the media signal on the remote audience side included in the audience data is selected as the transmission target, the decoding unit 154 functions as a smoothing processing unit that smooths the discontinuous points.

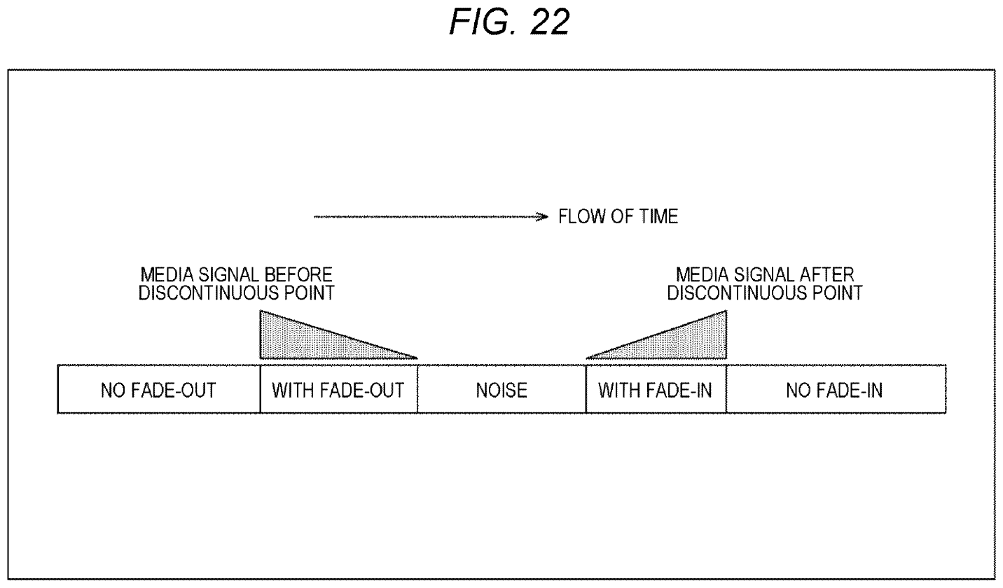

FIG. 22 is a diagram illustrating an example of smoothing processing.

In the smoothing processing, as illustrated in FIG. 22, a part of the signal in the latter half of the time series of the media signal before the discontinuous point is faded out (the amplitude is attenuated in proportion to the passage of time), and a part of the signal in the first half of the time series of the media signal after the discontinuous point is faded in (the amplitude is amplified in proportion to the passage of time).

Furthermore, the audio signal and the tactile signal are smoothed by interpolating the signal in the section that becomes the discontinuous point with, for example, an artificially synthesized noise signal. Further, the signal in the section that becomes the discontinuous point is interpolated with the image of the last frame of the video signal before the discontinuous point, whereby the video signal is smoothed.

In a case where a discontinuous point occurs in the media signal due to a delay or a defect, it is conceivable that the importance of the media signal is low, for example, there is no motion of the video, the remote audience does not emit sound, vibration, or the like, or the audio signal or tactile signal on the remote audience side includes only noise. Therefore, even with the simple smoothing as described above, the media signal can be reproduced with less sense of discomfort.

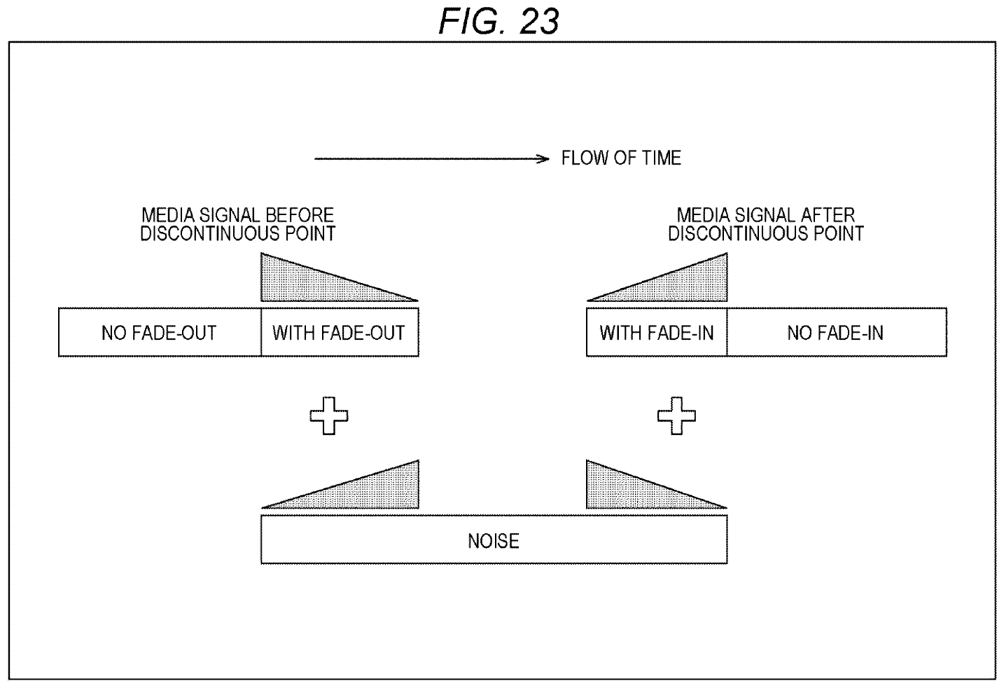

FIG. 23 is a diagram illustrating another example of the smoothing processing.

In the smoothing processing, as illustrated in FIG. 23, a noise signal extended forward and backward may be inserted into a section including a discontinuous point.

In this case, the noise signal in the same section as the fade-out section of the media signal before the discontinuous point fades in, and the noise signal in the same section as the fade-in section of the media signal after the discontinuous point fades out. By synthesizing (crossfading) the media signal and the noise signal before and after such a discontinuous point, the discontinuous point can be made more inconspicuous.

In addition, since the video signal is a time-series signal of a two-dimensional signal (image), each of the horizontal and vertical pixel signals is crossfaded. As described above, the smoothing processing includes fade processing of the time-series signal of the media signal.

### About Accessibility Support

In a case where the remote audience has some kind of disability, in the server 1, the media signal to be transmitted may be selected on the basis of context information indicating information regarding at least one of the visual sense, the auditory sense, or the tactile sense of the remote audience of the transmission destination.

For example, in a case where the remote audience is a blind person, then no video signal is needed as a media signal for the remote audience. By notifying the server 1 of context information indicating that the remote audience is a blind person in advance, it is not necessary to transmit a video signal to the transmission apparatus 54 used by the remote audience.

As a result, it is possible to spend communication resources corresponding to the video signal for transmission of the audio signal and the tactile signal, and it is possible to reduce the processing load of the server 1.

Similarly, for example, in a case where the remote audience is a person using a hearing aid or a deaf person due to hearing loss, the audio signal will have a lower priority or will not be needed. Therefore, communication resources corresponding to the audio signal can be spent for transmission of the video signal and the tactile signal, and the processing load of the server 1 can be reduced.

### About Computer

The series of processing described above can be executed by hardware or by software. In a case where the series of processing steps is executed by software, a program included in the software is installed from a program recording medium on a computer incorporated in dedicated hardware, a general-purpose personal computer, or the like.

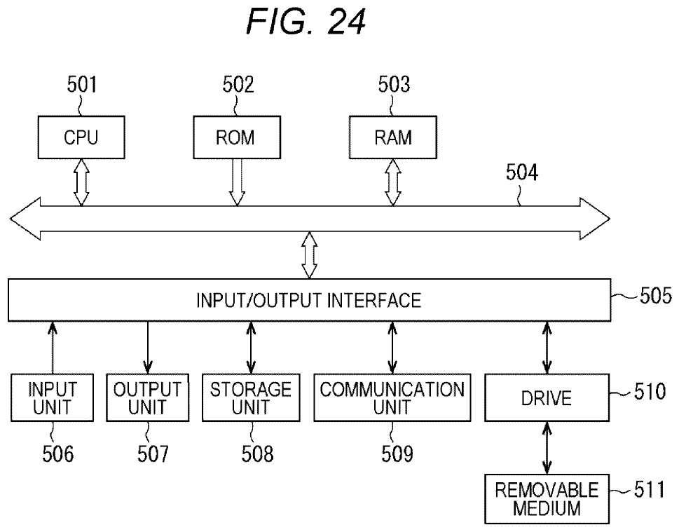

FIG. 24 is a block diagram illustrating a configuration example of hardware of a computer that executes the above-described series of processing by a program. The server 1, the transmission apparatus 14, and the transmission apparatus 54 include, for example, a PC having a configuration similar to the configuration illustrated in FIG. 24.

The CPU 501, the ROM 502, and the RAM 503 are connected to one another by a bus 504.

An input/output interface 505 is further connected to the bus 504. An input unit 506 including a keyboard, a mouse, and the like, and an output unit 507 including a display, a speaker, and the like are connected to the input/output interface 505. Furthermore, a storage unit 508 including a hard disk, a nonvolatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to execute the above-described series of processing.

For example, the program executed by the CPU 501 is recorded in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present specification, or may be a program in which the processing is performed in parallel or at a necessary timing such as when a call is made.

Note that, in the present specification, a system means an assembly of a plurality of components (apparatuses, modules (parts), and the like), and it does not matter whether or not all the components are located in the same housing. Therefore, a plurality of apparatuses accommodated in separate housings and connected via a network and one apparatus in which a plurality of modules is accommodated in one housing are both systems.

Note that the effects described in the present specification are merely examples and are not limited, and there may be other effects.

An embodiment of the present technology is not limited to the embodiment described above, and various modifications can be made without departing from the scope of the present technology.

For example, the present technology may be embodied in cloud computing in which a function is shared and executed by a plurality of apparatuses via a network.

Further, each step described in the flowchart described above can be performed by one apparatus or can be shared and performed by a plurality of apparatuses.

Moreover, in a case where a plurality of pieces of processing is included in one step, the plurality of pieces of processing included in the one step can be executed by one apparatus or executed by a plurality of apparatuses in a shared manner.

### Examples of Configuration Combinations

The present technology can also be configured as follows.
(1)

A transmission apparatus including:
an acquisition unit that acquires a media signal; a selection unit that selects the media signal of a transmission target on the basis of context information calculated for the media signal; and
a communication unit that transmits the media signal selected as the transmission target.
(2)

The transmission apparatus according to (1), in which the media signal includes at least one of a video signal, an audio signal, or a tactile signal.
(3)

The transmission apparatus according to (2), in which
the context information indicates a change amount of a luminance value of a video indicated by the video signal.
(4)

The transmission apparatus according to (2) or (3), in which
the context information indicates a degree of similarity between a voice indicated by the audio signal and a specific voice.
(5)

The transmission apparatus according to any one of (2) to (4), in which
the tactile signal includes at least one of a pressure applied to a device used by a user by the user or an acceleration of the device, and
the context information indicates an intensity or a change amount of at least one of the pressure or the acceleration.
(6)

The transmission apparatus according to any one of (1) to (5), further including
a storage unit that stores the media signal that has not been selected as the transmission target, in which
the selection unit selects the media signal as the transmission target from the media signal acquired by the acquisition unit and the media signal stored in the storage unit.
(7)

The transmission apparatus according to (6), in which
the media signal stored in the storage unit is discarded according to a transmission status by the communication unit.
(8)

The transmission apparatus according to (7), in which
the media signal that has not been selected as the transmission target a prescribed number of times by the selection unit or the media signal acquired by the acquisition unit before the media signal selected as the transmission target by the selection unit among the media signals stored in the storage unit is discarded.
(9)

The transmission apparatus according to (7), in which
the communication unit adds flag information indicating presence or absence of discard of the media signal to a header and transmits the media signal.
(10)

The transmission apparatus according to (1) or (2), in which
the acquisition unit receives a plurality of the media signals transmitted from devices respectively used by a plurality of users,
the selection unit mixes the media signals selected as the transmission target from the plurality of media signals acquired by the acquisition unit on the basis of the context information, and
the communication unit transmits the media signal mixed to each of the devices.
(11)

The transmission apparatus according to (10), in which
the context information indicates a degree of relationship between the user of the device of a transmission source and the user of the device of a transmission destination.
(12)

The transmission apparatus according to (11), in which
the degree of relationship includes a psychological distance of the user of the device of the transmission destination with respect to the user of the device of the transmission source.
(13)

The transmission apparatus according to (11) or (12), in which
the degree of relationship includes a distance in a virtual space between the user of the device of the transmission source and the user of the device of the transmission destination.
(14)

The transmission apparatus according to any one of (11) to (13), in which
the selection unit mixes the plurality of media signals at a mixing ratio according to the degree of relationship.
(15)

The transmission apparatus according to any one of (10) to (14), further including
a smoothing processing unit that performs smoothing processing of the media signal on the basis of flag information that is added to the media signal received by the acquisition unit and indicates presence or absence of discard of the media signal.
(16)

The transmission apparatus according to (15), in which
the smoothing processing includes fade processing of a time-series signal of the media signal.
(17)

The transmission apparatus according to any one of (10) to (16), in which
the context information indicates information regarding at least one of visual sense, auditory sense, or tactile sense of the user of the device of the transmission destination.
(18)

The transmission apparatus according to any one of (1) to (17), further including
a multiplexing unit that generates data obtained by multiplexing a plurality of types of the media signals selected as the transmission target, in which
the communication unit transmits the data.
(19)

A transmission method including:
by a transmission apparatus,
acquiring a media signal;
selecting the media signal of a transmission target on the basis of context information calculated for the media signal; and
transmitting the media signal selected as the transmission target.
(20)

A program for causing a computer to execute processing of:
acquiring a media signal;
selecting the media signal of a transmission target on the basis of context information calculated for the media signal; and
transmitting the media signal selected as the transmission target.

### REFERENCE SIGNS LIST

1 Server
51 Video input apparatus
52 Audio input apparatus
53 Tactile input apparatus
54 Transmission apparatus
55 Video output apparatus
56 Audio output apparatus
57 Tactile output apparatus
71 Encoding unit
72 Storage unit
73 Communication unit
74 Decoding unit
75 Control unit
91 Acquisition unit
92 Analysis unit
93 Compression unit
94 Selection unit
95 Multiplexing unit
151 Encoding unit
152 Storage unit
153 Communication unit
154 Decoding unit
155 Control unit
171 Selection unit
172 Compression unit
173 Multiplexing unit

1. A transmission apparatus comprising:
an acquisition unit that acquires a media signal;
a selection unit that selects the media signal of a transmission target on a basis of context information calculated for the media signal; and
a communication unit that transmits the media signal selected as the transmission target.

2. The transmission apparatus according to claim 1, wherein
the media signal includes at least one of a video signal, an audio signal, or a tactile signal.

3. The transmission apparatus according to claim 2, wherein
the context information indicates a change amount of a luminance value of a video indicated by the video signal.

4. The transmission apparatus according to claim 2, wherein
the context information indicates a degree of similarity between a voice indicated by the audio signal and a specific voice.

5. The transmission apparatus according to claim 2, wherein
the tactile signal includes at least one of a pressure applied to a device used by a user by the user or an acceleration of the device, and
the context information indicates an intensity or a change amount of at least one of the pressure or the acceleration.

6. The transmission apparatus according to claim 1, further comprising
a storage unit that stores the media signal that has not been selected as the transmission target, wherein
the selection unit selects the media signal as the transmission target from the media signal acquired by the acquisition unit and the media signal stored in the storage unit.

7. The transmission apparatus according to claim 6, wherein
the media signal stored in the storage unit is discarded according to a transmission status by the communication unit.

8. The transmission apparatus according to claim 7, wherein
the media signal that has not been selected as the transmission target a prescribed number of times by the selection unit or the media signal acquired by the acquisition unit before the media signal selected as the transmission target by the selection unit among the media signals stored in the storage unit is discarded.

9. The transmission apparatus according to claim 7, wherein
the communication unit adds flag information indicating presence or absence of discard of the media signal to a header and transmits the media signal.

10. The transmission apparatus according to claim 1, wherein
the acquisition unit receives a plurality of the media signals transmitted from devices respectively used by a plurality of users,
the selection unit mixes the media signals selected as the transmission target from the plurality of media signals acquired by the acquisition unit on a basis of the context information, and
the communication unit transmits the media signal mixed to each of the devices.

11. The transmission apparatus according to claim 10, wherein
the context information indicates a degree of relationship between the user of the device of a transmission source and the user of the device of a transmission destination.

12. The transmission apparatus according to claim 11, wherein
the degree of relationship includes a psychological distance of the user of the device of the transmission destination with respect to the user of the device of the transmission source.

13. The transmission apparatus according to claim 11, wherein
the degree of relationship includes a distance in a virtual space between the user of the device of the transmission source and the user of the device of the transmission destination.

14. The transmission apparatus according to claim 11, wherein
the selection unit mixes the plurality of media signals at a mixing ratio according to the degree of relationship.

15. The transmission apparatus according to claim 10, further comprising
a smoothing processing unit that performs smoothing processing of the media signal on a basis of flag information that is added to the media signal received by the acquisition unit and indicates presence or absence of discard of the media signal.

16. The transmission apparatus according to claim 15, wherein
the smoothing processing includes fade processing of a time-series signal of the media signal.

17. The transmission apparatus according to claim 10, wherein
the context information indicates information regarding at least one of visual sense, auditory sense, or tactile sense of the user of the device of the transmission destination.

18. The transmission apparatus according to claim 1, further comprising
a multiplexing unit that generates data obtained by multiplexing a plurality of types of the media signals selected as the transmission target, wherein
the communication unit transmits the data.

19. A transmission method comprising:
by a transmission apparatus,
acquiring a media signal;
selecting the media signal of a transmission target on a basis of context information calculated for the media signal; and
transmitting the media signal selected as the transmission target.

20. A program for causing a computer to execute processing of:
acquiring a media signal;
selecting the media signal of a transmission target on a basis of context information calculated for the media signal; and
transmitting the media signal selected as the transmission target.
